(19) United States
(12) Patent Application Publication
(10) Pub. No.: US 2022/0188075 A1
(43) Pub. Date: Jun. 16, 2022

(54) FLOATING POINT MULTIPLY-ACCUMULATE UNIT FOR DEEP LEARNING

(71) Applicant: Intel Corporation, Santa Clara, CA (US)

(72) Inventors: Arnab Raha, Santa Clara, CA (US); Mark A. Anders, Hillsboro, OR (US); Raymond Jit-Hung Sung, San Francisco, CA (US); Debabrata Mohapatra, San Jose, CA (US); Deepak Abraham Mathaikutty, Chandler, AZ (US); Ram K. Krishnamurthy, Portland, OR (US); Himanshu Kaul, Portland, OR (US)

(73) Assignee: Intel Corporation, Santa Clara, CA (US)

(21) Appl. No.: 17/688,131

(22) Filed: Mar. 7, 2022

(51) Int. Cl. G06F 7/544; G06F 7/483; G06N 3/08

(52) U.S. Cl. CPC G06F 7/5443; G06N 3/08; G06F 7/483

(57) ABSTRACT

A FPMAC operation has two operands: an input operand and a weight operand. The operands may have a format of FP16, BF16, or INT8. Each operand is split into two portions. The two portions are stored in separate storage units. Then operands are transferred to register files of a PE, with each register file storing bits of an operand sequentially. The PE performs the FPMAC operation based on the operands. The PE may include an FPMAC unit configured to compute an individual partial sum of the PE. The PE may also include an FP adder to accumulate the individual partial sum with other data, such as an output from another PE or an output form another PE array. The FP adder may be fused with the FPMAC unit in a single circuit that can do speculative alignment and has separate critical paths for alignment and normalization.

### TECHNICAL FIELD

This disclosure relates generally to neural networks, and more specifically, to accelerating deep neural networks (DNNs).

### BACKGROUND

DNNs are used extensively for a variety of artificial intelligence applications ranging from computer vision to speech recognition and natural language processing due to their ability to achieve high accuracy. However, the high accuracy comes at the expense of significant computation cost. DNNs have extremely high computing demands as each inference can require hundreds of millions of MAC (multiply-accumulate) operations as well as hundreds of millions of weight operand weights to be stored for classification or detection. Therefore, techniques to improve efficiency of DNNs are needed.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a layer architecture of an example DNN, in accordance with various embodiments.

FIG. 2 is a block diagram of a DNN accelerator, in accordance with various embodiments.

FIG. 3 illustrates a processing element (PE) array, in accordance with various embodiments.

FIG. 4 is a block diagram of a PE including an FPMAC unit, in accordance with various embodiments.

FIGS. 5A and 5B illustrate FPMAC operations by PEs, in accordance with various embodiments.

FIG. 6 illustrates operands encoded with a sparsity logic, in accordance with various embodiments.

FIG. 7 illustrates vector-vector FPMAC operations by a PE, in accordance with various embodiments.

FIG. 8 illustrates a matrix-matrix FPMAC operation by a PE, in accordance with various embodiments.

FIG. 9 illustrates partial sum accumulations within a PE column, in accordance with various embodiments.

FIG. 10 illustrates a deep learning environment, in accordance with various embodiments.

FIG. 11 is a block diagram of a DNN system, in accordance with various embodiments.

FIG. 12 is a flowchart showing a method of an FPMAC operation, in accordance with various embodiments.

FIG. 13 is a block diagram of an example computing device, in accordance with various embodiments.

### DETAILED DESCRIPTION

Overview

DNNs are widely used in the domains of computer vision, speech recognition, image, and video processing mainly due to their ability to achieve beyond human-level accuracy. However, the improvements in accuracy come at the expense of significant computation cost. The underlying DNNs have extremely high computing demands as each input requires at least hundreds of millions of MAC operations as well as hundreds of millions of weight operand weights to be processed for classification or detection. Energy constrained mobile systems and embedded systems, where energy and area budgets are extremely limited, often use area and energy efficient DNN accelerators as the underlying hardware for executing ML applications.

DNN models are usually trained using FP32 (single-precision floating-point format). Quantization for DNNs aims to retain inference-time model quality using integers, even though all training is done in floating point. However, not all inference applications perform well using quantized integers and hence DNN accelerators must continue to support floating point albeit at slightly lower bit precision. As a result, many DNN accelerators are built with the ability to perform MAC operations on FP16 (half-precision floating-point format) or BF16 (Brain floating-point format) activations and weights. Although FP16 is the most popular floating-point format among DNN accelerators, BF16 is rapidly gaining popularity due to its portability and efficient hardware implementation. BF16 has been proven to be easier to support in hardware as it can be easily converted from FP32 just by truncating the mantissa (with the exponent remaining the same). This allows us to train the networks at high bit precision (e.g., FP32) while the inference can happen at a lower bit precision with the conversion from FP32 to BF16 incurring a very small overhead. As a result, supporting both FP16 and BF16 floating-point modes becomes necessary for FP (floating-point)-based DNN operation.

Many conventional DNN accelerators support a fixed computational pattern within the PE driven by the reuse and dataflow and hence a traditional FPMAC can be used. However, for flexible compute DNN accelerators where the PE can have multiple compute patterns, the FPMAC requires additional arithmetic operators (such as FP adders) to support different compute patterns. In many DNN accelerators that support integer and floating-point modes of operation, the floating-point mode is clocked at a lower frequency compared to the integer mode of operation. This is because the floating-point operation is usually more complex and have a longer critical path. However, for newer applications (such as video, natural language processing, etc.), floating-point throughput is as important as integer throughput and both need to operate at a high frequency in the pipeline.

Within a DNN accelerator, the PE array can be the primary contributor of area and energy consumption in a DNN accelerator. Within the PE, usually the FPMAC unit, other than the Register File (RF) can be the largest contributor of area and power consumption. Since the MAC unit is implemented many times (such as thousands) within the DNN accelerator, improving the space efficiency, performance, and power efficiency of the floating-point MAC (FPMAC) unit can significantly improve two of the most important measurable metrics for DNN accelerators: (1) performance per unit area measured using the TOPS/mm² (Tera (10¹²) operations per mm²) metric, and (2) performance per unit energy measured using the TOPS/W (Tera (10¹²) operations per Watt) metric. Therefore, optimizations performed to the FPMAC unit can lead to improvement in space efficiency and energy efficiency. Even if there are additional bit precisions (such as INT8) supported by the PE, the FPMAC dominates any other bit precision logic within the PE due to its complexity. Since the PE is replicated multiple times (such as thousands) within the DNN accelerator, optimizing the FPMAC operation can lead to improvements in performance, space efficiency, and energy efficiency in the DNN accelerator.

However, there is not a lot of work that has been done to optimize half bit precision (e.g., FP16/BF16) FPMACs. Training mainly uses single bit precision floating point, FP32, and there is an increasing trend of inferencing using quantized DNN models of INT8/4/2/1 bit precisions that can lead to substantial energy gains. For lower fixed-point bit precisions, the promise of energy gains come at the expense of accuracy loss that may not be acceptable for some applications (such as safety critical applications such autonomous driving, etc.). As a result, supporting floating-point bit precision becomes indispensable for DNN accelerators and FPMAC becomes a main consumer of space and power and becomes a performance bottleneck. Also, conventional FPMAC circuits usually fail to include critical path optimizations. Therefore, improved technologies for FPMAC are needed to improve performance, space efficiency, and energy efficiency of DNN accelerators.

Embodiments of the present disclosure provide apparatus and methods for FPMAC operations. With the present disclosure, DNN accelerators can have higher efficiency in space and power and achieve better performance. An example apparatus may be a DNN accelerator that includes a data storing module, a concatenating module, and a PE array. The data storing module splits an operand of an FPMAC operation into two portions and stores the two portions in separate storage units, such as separate banks of a SRAM (static random-access memory). An FPMAC operand may be either an input operand or a weight operand. An input operand (also referred to as “context”) includes input data to be used by a PE to perform an FPMAC operation. A weight operand includes filter data to be used by the PE to perform an FPMAC operation. In some embodiments, an operand is in a format of FP16, BF16, or INT8. One of the two portions can be the first half of the operand, e.g., the eight upper bits in the operands. The other one of the two portions can be the second half of the operand, e.g., the eight lower bits in the operands. In some embodiments, bitmaps of the two portions are identical so that the sparsity logic for FP16/BF16 can also be used for INT8.

The concatenating module concatenates FPMAC operands. For instance, the concatenating module links data from the two separate storage units of an input operand and stores the bits sequentially in an input register file of a PE in the PE array. Similarly, the concatenating module links data from the two separate storage units of the weight operand and stores the bits sequentially in a weight register file of a PE. The PE also has an FPMAC unit that performs the FPMAC operation. The FPMAC unit may be fed with bits in the input operand and bit in the weight operand sequentially and performs a series of multiplication operations, each of which is a multiplication of a bit in the input operand with a bit in the weight operand. The FPMAC unit also accumulates the results of the multiplication operations and generates a an individual partial sum of the PE. The individual partial sum may have a different bit precision from the input operand or weight operand. The PE may also accumulate the individual partial sum with an output of another PE in the same PE array and generate an internalpartial sum of the PE array. In some embodiments, external partial sum accumulation is also needed. External partial sum accumulation may be an accumulation of an external partial sum with an internal partial sum. The external partial sum may be an output from another PE array, which may be in the same DNN layer as the PE array.

Accumulation of FP numbers requires alignment of the exponents in the FP numbers and normalization of the exponent in the sum. The PE may have a circuit that facilitates speculative alignment, e.g., the exponents can be aligned before it is determined which exponent is larger. Also, the critical paths for alignment and normalization may be separated. Normalization may even be delayed, e.g., the next accumulation cycle, to enable the normalization critical path operate in parallel with the alignment critical path. Therefore, the present disclosure provides flexibilities with respect to FP formats and FP accumulation.

The present disclosure also provides flexibilities with respect to computer pattern. For instance, the PE may include multiple FPMAC units to perform FPMAC operations with various compute patterns. Example compute patterns include vector-vector (i.e., a vector of input channels with a vector of weights), matrix-vector (i.e., a matrix of input channels with a vector of weights), matrix-matrix (i.e., a matrix of input channels with a matrix of weights), etc. With these flexibilities, FPMAC units of the present disclosure have higher space efficiency, compared with conventional FPMAC units, such as FPMAC units tailed to one FP format or one compute pattern. Also, with speculative alignment and separated critical paths for alignment and normalization, partial sum accumulations can have lower latency. The performance of DNN accelerators can therefore be improved.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The DNN accelerators, methods and devices of this disclosure each have several innovative aspects, no single one of which is solely responsible for all desirable attributes disclosed herein. Details of one or more implementations of the subject matter described in this specification are set forth in the description below and the accompanying drawings.

Example DNN Layer Architecture

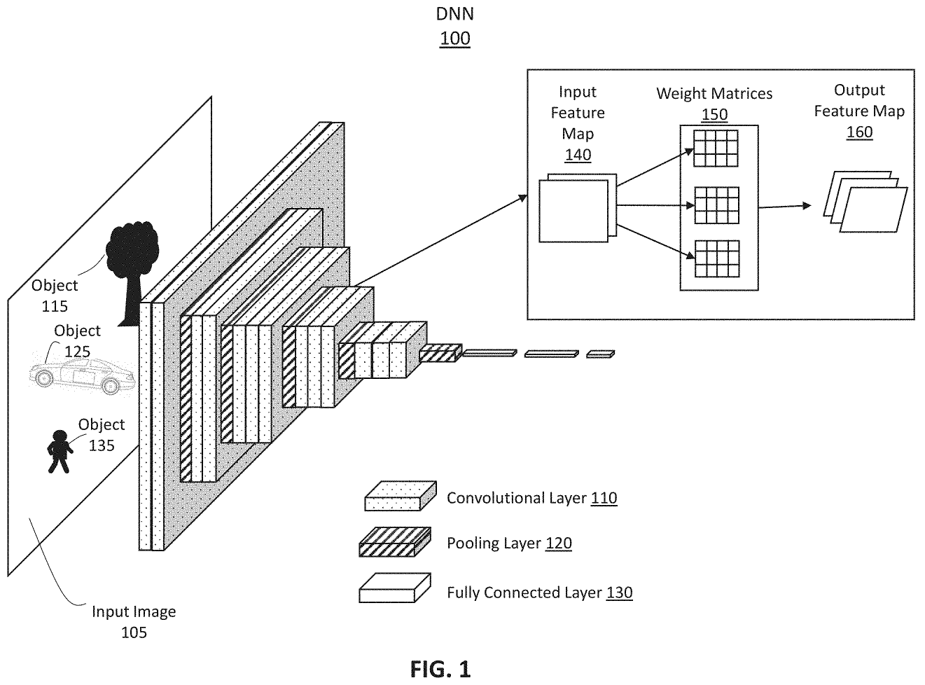

FIG. 1 illustrates a layer architecture of an example DNN 100, in accordance with various embodiments. For purpose of illustration, the DNN 100 in FIG. 1 is a Visual Geometry Group (VGG)-based convolutional neural network (CNN). In other embodiments, the DNN 100 may be other types of DNNs. The DNN 100 is trained to receive images and output classifications of objects in the images. In the embodiment of FIG. 1, the DNN 100 receives an input image 105 that includes objects 115, 125, and 135. The DNN 100 includes a sequence of layers comprising a plurality of convolutional layers 110 (individually referred to as “convolutional layer 110”), a plurality of pooling layers 120 (individually referred to as “pooling layer 120”), and a plurality of fully connected layers 130 (individually referred to as “fully connected layer 130”). In other embodiments, the DNN 100 may include fewer, more, or different layers.

The convolutional layers 110 summarize the presence of features in the input image 105. The convolutional layers 110 function as feature extractors. The first layer of the DNN 100 is a convolutional layer 110. In an example, a convolutional layer 110 performs a convolution to an IFM 140 by using weight matrices 150, generates an OFM 160 from the convolution, and passes the OFM 160 to the next layer in the sequence. The IFM 140 may include a plurality of IFM matrices. The OFM 160 may include a plurality of OFM matrices. For the first convolutional layer 110, which is also the first layer of the DNN 100, the IFM 140 is the input image 105. For the other convolutional layers, the IFM 140 may be an output of another convolutional layer 110 or an output of a pooling layer 120. The convolution is a linear operation that involves the multiplication of the weight matrices 150 with the IFM 140. A weight matrix (also referred to as a weight operand) may be a 2-dimensional array of weights, where the weights are arranged in columns and rows. Weights can be initialized and updated by backpropagation using gradient descent. The magnitudes of the weights can indicate importance of the weight matrices 150 in extracting features from the IFM 140. A weight operand can be smaller than the IFM 140.

The multiplication applied between a weight operand-sized patch of the IFM 140 and a weight operand may be a dot product. A dot product is the element-wise multiplication between the weight operand-sized patch of the IFM 140 and the corresponding weight operand, which is then summed, always resulting in a single value. Because it results in a single value, the operation is often referred to as the “scalar product.” Using a weight operand smaller than the IFM 140 is intentional as it allows the same weight operand (set of weights) to be multiplied by the IFM 140 multiple times at different points on the IFM 140. Specifically, the weight operand is applied systematically to each overlapping part or weight operand-sized patch of the IFM 140, left to right, top to bottom. The result from multiplying the weight operand with the IFM 140 one time is a single value. As the weight operand is applied multiple times to the IFM 140, the multiplication result is a two-dimensional array of output values that represent a weight operanding of the IFM 140. As such, the 2-dimensional output array from this operation is referred to a “feature map.”

In some embodiments, the OFM 160 is passed through an activation function. An example activation function is the rectified linear activation function (ReLU). ReLU is a calculation that returns the value provided as input directly, or the value zero if the input is zero or less. The convolutional layer 110 may receive several images as input and calculates the convolution of each of them with each of the weight operands. This process can be repeated several times. For instance, the OFM 160 is passed to the subsequent convolutional layer 110 (i.e., the convolutional layer 110 following the convolutional layer 110 generating the OFM 160 in the sequence). The subsequent convolutional layers 110 performs a convolution on the OFM 160 with new weight operands and generates a new feature map. The new feature map may also be normalized and resized. The new feature map can be weight operanded again by a further subsequent convolutional layer 110, and so on.

In some embodiments, a convolutional layer 110 has four hyperparameters: the number of weight operands, the size F weight operands (e.g., a weight operand is of dimensions F×F×D pixels), the S step with which the window corresponding to the weight operand is dragged on the image (e.g., a step of one means moving the window one pixel at a time), and the zero-padding P (e.g., adding a black contour of P pixels thickness to the input image of the convolutional layer 110). The convolutional layers 110 may perform various types of convolutions, such as 2-dimensional convolution, dilated or atrous convolution, spatial separable convolution, depth-wise separable convolution, transposed convolution, and so on. The DNN 100 includes 16 convolutional layers 110. In other embodiments, the DNN 100 may include a different number of convolutional layers.

The pooling layers 120 downsample feature maps generated by the convolutional layers, e.g., by summarizing the presents of features in the patches of the feature maps. A pooling layer 120 is placed between two convolution layers 110: a preceding convolutional layer 110 (the convolution layer 110 preceding the pooling layer 120 in the sequence of layers) and a subsequent convolutional layer 110 (the convolution layer 110 subsequent to the pooling layer 120 in the sequence of layers). In some embodiments, a pooling layer 120 is added after a convolutional layer 110, e.g., after an activation function (e.g., ReLU) has been applied to the OFM 160.

A pooling layer 120 receives feature maps generated by the preceding convolution layer 110 and applies a pooling operation to the feature maps. The pooling operation reduces the size of the feature maps while preserving their important characteristics. Accordingly, the pooling operation improves the efficiency of the DNN and avoids over-learning. The pooling layers 120 may perform the pooling operation through average pooling (calculating the average value for each patch on the feature map), max pooling (calculating the maximum value for each patch of the feature map), or a combination of both. The size of the pooling operation is smaller than the size of the feature maps. In various embodiments, the pooling operation is 2×2 pixels applied with a stride of two pixels, so that the pooling operation reduces the size of a feature map by a factor of 2, e.g., the number of pixels or values in the feature map is reduced to one quarter the size. In an example, a pooling layer 120 applied to a feature map of 6×6 results in an output pooled feature map of 3×3. The output of the pooling layer 120 is inputted into the subsequent convolution layer 110 for further feature extraction. In some embodiments, the pooling layer 120 operates upon each feature map separately to create a new set of the same number of pooled feature maps.

The fully connected layers 130 are the last layers of the DNN. The fully connected layers 130 may be convolutional or not. The fully connected layers 130 receives an input operand. The input operand defines the output of the convolutional layers 110 and pooling layers 120 and includes the values of the last feature map generated by the last pooling layer 120 in the sequence. The fully connected layers 130 applies a linear combination and an activation function to the input operand and generates an individual partial sum. The individual partial sum may contain as many elements as there are classes: element i represents the probability that the image belongs to class i. Each element is therefore between 0 and 1, and the sum of all is worth one. These probabilities are calculated by the last fully connected layer 130 by using a logistic function (binary classification) or a softmax function (multi-class classification) as an activation function.

In some embodiments, the fully connected layers 130 classify the input image 105 and returns a operand of size N, where N is the number of classes in the image classification problem. In the embodiment of FIG. 1, N equals 3, as there are three objects 115, 125, and 135 in the input image. Each element of the operand indicates the probability for the input image 105 to belong to a class. To calculate the probabilities, the fully connected layers 130 multiply each input element by weight, makes the sum, and then applies an activation function (e.g., logistic if N=2, softmax if N>2). This is equivalent to multiplying the input operand by the matrix containing the weights. In an example, the individual partial sum includes three probabilities: a first probability indicating the object 115 being a tree, a second probability indicating the object 125 being a car, and a third probability indicating the object 135 being a person. In other embodiments where the input image 105 includes different objects or a different number of objects, the individual partial sum can be different.

Example DNN Accelerator

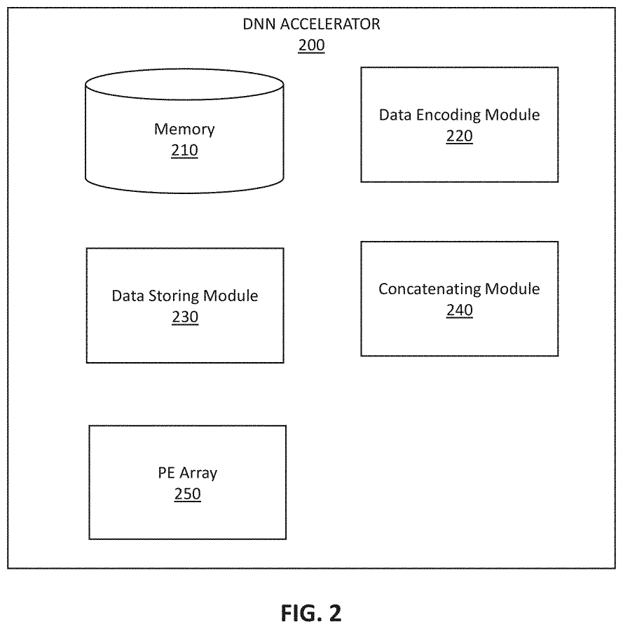

FIG. 2 is a block diagram of a DNN accelerator 200, in accordance with various embodiments. The DNN accelerator 200 may be a DNN layer (e.g., a convolutional layer 110), or a portion of a DNN layer. The DNN accelerator may perform deep learning operations with data in various formats, such as FP16, BF16, FP32, INT8, etc. The DNN accelerator 200 includes a memory 210, a data encoding module, a data storing module 230, a concatenating module 240, and a PE array 250. In some embodiments, the DNN accelerator 200 may include more, fewer, or different components. For instance, the DNN accelerator 200 may include multiple PE arrays. A component of the DNN accelerator 200 may be arranged externally to the DNN accelerator 200. Also, some of all functions of a component may be performed by a different component of the DNN accelerator 200 or an external system.

The memory 210 stores data associated with MAC operations. For instance, the memory stores some or all of the input, filters, and output of a DNN layer. In some embodiments, the memory 210 is a SRAM. The memory 210 may be byte-addressable, and each memory address identifies a single byte (eight bits) of storage. The memory 210 includes a plurality of storage units, each of which stores a single byte and has a memory address. Data larger than a single byte may be stored in storage units with consecutive memory addresses, i.e., adjacent storage units. For instance, two storage units may be needed to store a number in the FP16 or BF16 format, which has 16 bits. In some embodiments, 16 bits can be transferred from the memory 210 in a single reading cycle. In other embodiments, 16 bits can be transferred from the memory 210 in multiple reading cycles, such as two cycles.

The data encoding module 220 encodes data for MAC operations and generates MAC operands. The data encoding module 220 may encode data based on one or more data formats, such as FP16, BF16, FP32, INT8, other formats, or some combination thereof. For an FPMAC operation, the data encoding module 220 may generate FPMAC operands. FPMAC operands are data used to perform FPMAC operations by the PE array 250. An FPMAC operand includes a plurality of bits. The values in an FPMAC operand may be zero values, non-zero values, or a combination of both. In some embodiments, an FPMAC operation is associated with two FPMAC operands: an input operand and a weight operand. An input operand may include the input channels to be used by a PE to perform the FPMAC operation. A weight operand may be a weight to be used by the PE to perform the FPMAC operation.

In some embodiments, an operand is in a format of FP16 or BF16 and has 16 bits. A FP16 operand may include a bit representing sign, five bits representing exponent, and ten bits representing mantissa (i.e., the part of a floating-point number that represents the significant digits of that number, and that is multiplied by the base raised to the exponent to give the actual value of the number). A BF16 operand may include a bit representing sign, eight bits representing exponent, and seven bits representing mantissa. One of the two portions of an operand can be the first half of the operand, e.g., the eight upper bits in the operand. This portion is also referred to as the upper portion. In embodiments where the operand includes 16 bits, the upper portion is also referred to as the upper byte. The other one of the two portions can be the second half of the operand, e.g., the eight lower bits in the operand. This portion is also referred to as the lower portion. In embodiments where the operand includes 16 bits, the lower portion is also referred to as the lower byte. A bit in a portion has a rank of that portion. For instance, the first bit in the upper portion has a rank of one in the upper portion, the second bit has a rank of two, and so on. Similarly, the first bit in the lower portion has a rank of one in the lower portion, the second bit has a rank of two, and so on.

In some embodiments (such as embodiments where the DNN accelerator 200 uses find-first sparsity logic), the data encoding module 220 encodes an FPMAC operand by looking at the upper portions and the lower portions together, i.e., the two portions are not encoded independently. For instance, the data encoding module 220 assign a zero to a byte (either the upper byte or lower byte) when both bytes are zero, in which case the entire input operand or weight operand is zero. When either the upper byte or lower byte is not zero, the data encoding module 220 would not assign a zero to either byte. The upper portion may have the same bitmap as the lower portion. A bitmap of a portion is a map of bits in the portion and shows whether each bit is zero or one. In embodiments where the upper portion may have the same bitmap as the lower portion, the two portions have the same bits that are arranged in the same sequence. By encoding the upper portion and lower portion together, the sparsity logic an also work with data in INT8 format. That way, additional components for INT8 bit precision can be avoided to save space and energy.

The data storing module 230 stores FPMAC operands in the memory 210. For instance, the data storing module 230 stores the upper portion and the lower portion of an operand in two separate storage units of the memory 210. The data storing module 230 may store the upper portion in a first storage unit and store the lower portion in a second storage unit. The first storage unit may be adjacent to the second storage unit in the memory. In embodiments where the storage units are arranged sequentially, the second storage unit may be adjacently subsequent to the first storage unit.

In some embodiments, the data storing module 230 stores an output of the DNN layer, e.g., the output of the PE array 250 in the memory 210. The data storing module 230 may divide the output into two portions and load the two portions to two separate storage units of a drain buffer associated with the PE array 250. The two portions may be further transferred from the two separate storage units of the drain buffer to two separate storage units of the memory, respectively. The output may be used as an input operand by further FPMAC operations of another PE array, e.g., a PE array of a different DNN layer.

The concatenating module 240 reads data from the memory 210 and feeds the data sequentially into register files of PEs. In an example, the concatenating module 240 reads two portions of an operand from two separate storage units of the memory 210 and link the two portions to create the operand. For instance, the concatenating module 240 put the lower portion after the upper portion. Further, the concatenating module 240 feeds the bits in the operand (e.g., bits of the upper potion followed by bits of the lower portion) into a register file of a PE. In some embodiments, the concatenating module 240 may feed an input operand in an input register file, and feed a weight operand in a weight register file.

The rank of a bit in the register file may be the same as the rank of the bit in the operand, but may be different from the rank of the bit in the operand portion. For instance, the first bit in the lower portion, which has a rank of one in the lower portion, has a rank of nine in the operand, and the second bit the lower portion, which has a rank of two the lower portion, has a rank of ten in the operand. In some embodiments, each bit in the upper portion has the same rank in the upper portion and in the operand, but each bit in the lower portion has a different rank in the upper portion than in the operand.

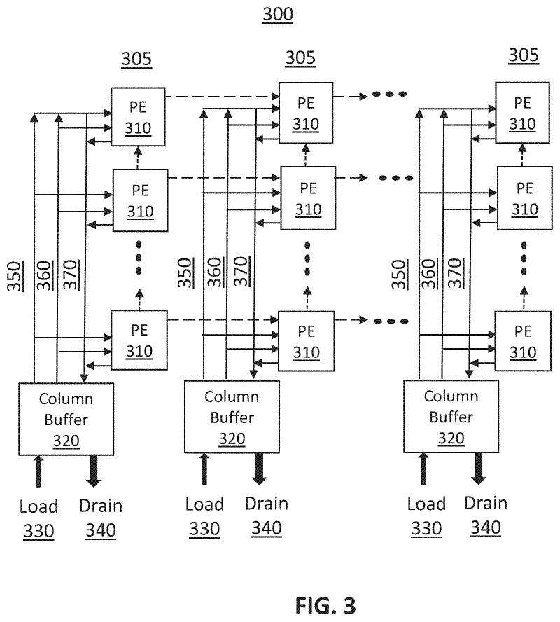

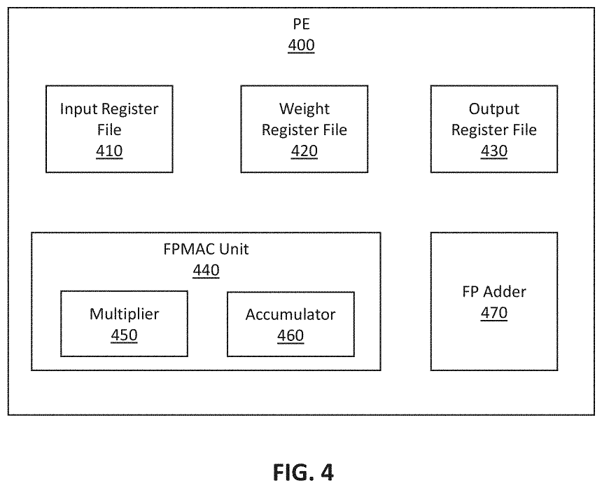

The PE array 250 is an array of PEs, where the PEs may be arranged in columns and rows. The PE array 250 performs MAC operations, including FPMAC operations. The PE array 250 may be a tile, or a portion of a tile, of a DNN layer having a tile architecture. The DNN layer may includes one or more other PE arrays that may operate in parallel with the PE array 250. In some embodiments, the PE array 250 receive an IFM and filters of a DNN layer and generates the OFM of the layer through the MAC operations. The OFM may be used as an IFM of a subsequent layer. More details regarding the PE array 250 are described below in conjunction with FIGS. 3 and 4.

FIG. 3 illustrates a PE array 300, in accordance with various embodiments. The PE array 300 is an embodiment of the PE array 250 in FIG. 2. The PE array 300 includes a plurality of PEs 310 (individually referred to as “PE 310”). The PEs 310 perform MAC operations. The PEs 310 may also be referred to as neurons in the DNN. Each PE 310 has two input signals 350 and 360 and an output signal 370. The input signal 350, e.g., is a portion of the input (e.g., a portion of an IFM) to the layer. The input signal 360 is a portion of the weights of the layer. The weights can have non-zero values and zero values. The values of the weights are determined during the process of training the DNN. The weights can be divided and assigned to the PEs based on bitmaps. In some embodiments, the input signal 350 of a PE 310 is an input operand, and the input signal 360 is a weight operand.

Each PE 310 performs an MAC operation on the input signals 350 and 360 and outputs the output signal 370, which is a result of the MAC operation. Some or all of the input signals 350 and 360 and the output signal 370 may be in an FP format, such as FP16 or BF16, or in an integer format, such as INT8. For purpose of simplicity and illustration, the input signals and output signal of all the PEs 310 have the same reference numbers, but the PEs 310 may receive different input signals and output different output signals from each other. Also, a PE 310 may be different from another PE 310, e.g., include different register files, different FPMAC units, etc.

As shown in FIG. 3, the PEs 310 are connected to each other, as indicated by the dash arrows in FIG. 3. The output signal 370 of an PE 310 is sent to many other PEs 310 (and possibly back to itself) as input signals via the interconnections between PEs 310. In some embodiments, the output signal 370 of an PE 310 may incorporate the output signals of one or more other PEs 310 through an accumulate operation of the PE 310 and generates an internal partial sum of the PE array. More details about the PEs 310 are described below in conjunction with FIG. 3B.

In the embodiment of FIG. 3, the PEs 310 are arranged into columns 305 (individually referred to as “column 305”). The input and weights of the layer may be distributed to the PEs 310 based on the columns 305. Each column 305 has a column buffer 320. The column buffer 320 stores data provided to the PEs 310 in the column 305 for a short amount of time. The column buffer 320 may also store data output by the last PE 310 in the column 305. The output of the last PE 310 may be a sum of the MAC operations of all the PEs 310 in the column 305, which is a column-level internal partial sum of the PE array 300. In other embodiments, input and weights may be distributed to the PEs 310 based on rows in the PE array 300. The PE array 300 may include row buffers in lieu of column buffers 320. A row buffer may store input signals of the PEs in the corresponding row and may also store a row-level internal partial sum of the PE array 300.

As shown in FIG. 3, each column buffer 320 is associated with a load 330 and a drain 340. The data provided to the column 305 is transmitted to the column buffer 320 through the load 330. In some embodiments, the load 330 may be facilitated by the concatenating module 240 in FIG. 1. The data generated by the column 305 is extracted from the column buffers 320 through the drain 340. In some embodiments, data extracted from a column buffer 320 is sent to upper memory hierarchies, e.g., the memory 210 in FIG. 2, through the drain operation. In some embodiments, the drain operation does not start until all the PEs 310 in the column 305 has finished their MAC operations. The drain operation may be facilitated by the data storing module 230 in FIG. 2.

FIG. 4 is a block diagram of a PE 400 including an FPMAC unit 440, in accordance with various embodiments. The PE 400 may be an embodiment of the PE 310 in FIG. 3. In addition to the FPMAC unit 440, the PE 400 includes an input register file 410, a weight register file 420, an output register file 430, and an FP adder 470. In other embodiments, the PE 400 may include fewer, more, or different components.

The input register file 410 temporarily stores input operands for MAC operations by the PE 400. The input operands include data in the input feature map of the DNN layer. In some embodiments, the input register file 410 may store a single input operand at a time. The bits of an input operand are stored sequentially in the input register file 410 so the bits can be accessed by the FPMAC unit 440 sequentially. A rank of each bit in the input operand may match a rank of the bit in the input register file 410. The input register file 410 may also temporarily store individual partial sums from another PE, such as a PE that is adjacent to the PE 400 in a PE array. The other PE may be arranged in a same column or row as the PE 400. The individual partial sums from the other PE may be used to compute, by the PE 400, an internal partial sum of the PE array.

The weight register file 420 temporarily stores weight operands for MAC operations by the PE 400. The weight operands include data in the filters of the DNN layer. In some embodiments, the weight register file 420 may store a single weight operand at a time. The bits of a weight operand are stored sequentially in the weight register file 420 so the bits can be accessed by the FPMAC unit 440 sequentially. A rank of each bit in the weight operand may match a rank of the bit in the weight register file 420.

The output register file 430 temporarily stores individual partial sums generated by the PE 400. For purpose of illustration and simplicity, the PE 400 in FIG. 4 includes one input register file 410, one weight register file 420, one output register file 430. In other embodiments, a PE 400 may include multiple input register files, multiple weight register files, or multiple output register files.

The FPMAC unit 440 performs FPMAC operations on data stored in the input register file 410 and weight register file 420. The FPMAC unit 440 includes a multiplier 450 and an accumulator 460. The multiplier 450 performs multiplication operations on input operands stored in the input register file 410 and weight operands stored in the weight register file 420. For an input operand and a weight operand, the multiplier 450 may be fed with the bits in the input operand and the bits in the weight operand serially and may perform a series of multiplication operations. Each multiplication operation in the series may be a multiplication of a bit in the input operand with a bit in the weight operand. The rank of the bit in the input operand equals the rank of the bit in the weight operand. In some embodiments, the input operand and weight operand are FP numbers in the same FP format, such as FP16 or BF16, and the multiplier 450 performs FP16 or BF16 multiplications.

The accumulator 460 performs accumulation operations on the results of the multiplier 450. For instance, the accumulator 460 accumulates the results of all the multiplication operations in a series of multiplication operations. The result of the accumulation may be referred to as an individual partial sum of the PE 400, or of the FPMAC unit 440. The individual partial sum may be stored temporarily in the output register file 430. In some embodiment, the accumulator 460 may perform FP16 or BF16 accumulations. The individual partial sum may have the same bit precision, e.g., the same data format, as the input operand, the weight operand, or a result of a multiplication operation by the multiplier 450. In other embodiments, the individual partial sum may have a different bit precision from the input operand, the weight operand, or a result of a multiplication operation by the multiplier 450. For instance, the accumulator 460 may perform FP32 accumulations, and the individual partial sum may have FP32 format.

An FPMAC operation with an input operand and a weight operand includes the series of multiplication operations by the multiple 450 and the accumulation operation by the accumulator 460. The PE 400 can perform other accumulation operations, such as internal partial sum accumulations and external partial sum accumulations, through the FP adder 470.

The FP adder 470 performs partial sum accumulations. The FP adder 470 may perform internal partial sum accumulations. An internal partial sum accumulation is an accumulation of data internal with respect to a PE array. An internal partial sum accumulation may be an accumulation of two or more individual partial sums of PEs in the same PE array, an accumulation of an individual partial sum of a PE in the PE array with an internal partial sum of the PE array, or an accumulation of two or more internal partial sums of the PE array. An internal partial sum is a sum of multiple individual partial sums. In an example, an internal partial sum may be a column-level internal partial sum, which is a sum of the individual partial sums of all the PEs in a column of the PE array. In another example, an internal partial sum may be a row-level internal partial sum, which is a sum of the individual partial sums of all the PEs in a row of the PE array. A PE array may have a plurality of internal partial sums.

Additionally or alternatively, the FP adder 470 may perform external partial sum accumulations. An external partial sum accumulation is an accumulation based on an external partial sum. An external partial sum may be an output from a PE array that is different from the PE array where the PE 400 is located. Alternatively, the external partial sum may be an output from a PE column or row that is different from the column or row where the PE 400 is located, e.g., in embodiments where different columns or rows of a PE arrayed are handled by different threads.

In some embodiments, an external partial sum accumulation is an accumulation of an external partial sum with an individual partial sum of the PE 400. In other embodiments, an external partial sum accumulation is an accumulation of an external partial sum with an internal partial sum of the PE array where the PE 400 is located. In some embodiments (such as embodiments where the FP adder 470 performs both internal accumulation and external accumulation), the FP adder 470 may operate with a different bit precision or different FP format from the multiplier 450. A partial sum may have the different bit precision or different FP format from results of multiplication operations of the multiplier 450. The FP adder 470 may operate with the same bit precision or FP format as the accumulator 460. In an example, FP adder 470 operates with FP32 format.

Addition of two FP inputs typically requires alignment of the exponents in the two inputs. Usually, the exponents of the two FP inputs need to be compared to determine which one is larger. For instance, an exponent of 1 is larger than an exponent of −2. In an example where the first FP input has the larger exponent, the second FP input is promoted from the smaller exponent to the larger exponent by moving the binary point to the left so that the exponents of the two FP inputs can match. Then the addition can be performed. In the present disclosure, accumulation of FP numbers (by the accumulator 460 or FP adder 470) may include speculative alignment. For instance, a first exponent in a first FP input can be changed based on a second exponent in a second FP input before (or without) determining whether the second exponent is larger than the first exponent. The first input or second FP input may be a result of a multiplication operation (also referred to as “product”), an individual partial sum, an internal partial sum, an external partial sum, etc.

Addition of the two FP inputs may also require normalization of at least one of the FP inputs or the FP sum (i.e., the result of the addition). In some embodiments, the number of mantissa bits in an FP number may need to be adjusted (e.g., some bits in the mantissa may need to be truncated) to meet the number of mantissa bits in the FP format. Further, the exponent bits may be determined based on the number of exponent bits in the FP format. Normalization of an FP number may include a change of the exponential form of the FP number, e.g., to meet the FP format (such as FP16, BF16, or FP 32). In some embodiments, normalization of an FP number may include removal of one or more leading zeros in the FP number. The leading zeros may be zero valued bits that come before non-zero valued bits in the FP number. A normalized FP number may have no leading zeros. Also, the decimal point may be moved, and the exponent may be adjusted in accordance with the removal of the leading zeros.

Even though FIG. 4 shows that the multiplier 450, accumulator 460, and FP adder 470 are separate units, they may have different arrangements. For instance, the accumulator 460 and the FP adder 470 may be a single accumulation unit that performs the functions of both the accumulator 460 and the FP adder 470. In some embodiments, the FP adder 470 is “fused” with the FPMAC unit 440 in a single electronic circuit (also referred to as “circuit”), as opposed to separate circuits. The single electronic circuit of the PE 400 can perform multiplications and accumulations, such as the multiplication operations and accumulation operations of the FPMAC unit 440 and the FP adder 470. The fusion of the FP adder 470 with the FPMAC unit 440 can reduce the total area needed by the PE 400 and improve space efficiency of the DNN accelerator. The circuit may include a first path for exponent adjustment and a second path for normalization. A path may be a critical path from an input to an output in the circuit. The first path may be an alignment critical path, and the second path may be a normalization critical path. In some embodiments, the two paths are separate.

In an example circuit implementing both the FPMAC unit 440 and the FP adder 470, both FP16 and BF16 input formats may be supported in the multiplier. The FP16 format may support denormal inputs, which requires a normalization stage to remove leading zeros. The mantissa multiplier inputs select the appropriate bits from the inputs depending on whether the inputs are in FP16 or BF16 format before entering the multiplier. In parallel with the multiplier, leading zeros are detected within FP16 inputs, and the exponent of an FP16 product (e.g., a product of an FP16 multiplication performed by the multiplier) can be calculated by adding the input exponent and adjusting for the leading zeros. For FP16 mode, leading zeros may be removed using a normalization shifter following the multiplier. A final stage of normalization is needed when the upper product bit from the multiplier is 0. This may be done at the start of the accumulate cycle to shorten the multiplier critical path. Zero/NaN/Infinity inputs are detected in the multiplier and signals are forwarded to the adder to avoid the need for separate detection of these special cases within the critical accumulate loop. These optimizations enable efficient support for both FP16 and BF16 input formats.

The accumulator single-cycle loop begins with exponent comparison and difference between the exponent of the product and the exponent of another FP number (e.g., another product, an individual partial sum, internal partial sum, or external partial sum). The last stage of product normalization occurs in parallel with this exponent subtraction to take advantage of extra timing slack in the mantissa path. Next, a two-stage speculative alignment shift is performed on both inputs based on the two lower bits of the exponent difference, before it is known which is the larger exponent. When the larger exponent is determined, multiplexers may select the correct mantissa as the larger, as well as the correct speculatively shifted mantissa as the smaller. This can reduce the alignment critical path by shifting both mantissas based on the lower two bits of the difference before it is known which has the smaller exponent. After the smaller exponent is known, the smaller mantissa is then aligned using the final three stages of alignment shifting. In this way, the speculative shift removed two shifter stages from the critical path by performing them before selecting the larger/smaller mantissas.

For exponent differences of 0/1 or for subtract operations, the final three alignment shift stages can be avoided. Detection of potential upper bit cancellation may be detected speculatively using two LZA (leading zero anticipators), each with one of the inputs shifted right by one bit using the first stage of the speculative alignment shifters. The correct leading zero count may be selected after the bigger exponent is determined. Two mantissa adders are used to enable the mantissa subtraction to begin earlier before the final three alignment stages are finished. Large mantissa normalization and inversion (when negative) are needed for this path but may not be needed for other paths, since the fully aligned path may not handle cases of bit cancellation. The correct result following the mantissa adders is selected based on the exponent difference and add/subtract operation.

Two stages of normalization, rounding, and handling special case numbers may be needed. To reduce the critical path, these operations are performed at the beginning of the next accumulation cycle, in parallel with the exponent comparison and difference. When the accumulator result is needed after multiple accumulation cycles, these final operations are performed separately outside the accumulate loop.

In addition to these critical path improvements, the accumulator was extended to support reconfigurability for FP32 add operations. For an FP32 add, the two FP16 or BF16 multiplier inputs are reinterpreted as a single FP32 input to the adder. The multiplier circuits are bypassed and this FP32 input can be added to the FP32 accumulator seed input in the accumulation stage. This allows the same FPMAC circuit to be used for MAC operations as well as for summing FP32 results.

Such a circuit can have multiple advantages. For example, speculative alignment can be used to take advantage of slack in the mantissa path relative to the exponent logic. Also, alignment and normalization paths within FP adder can be separated to avoid the need for both alignment and normalization in the critical path. Further, non-FP32 feedback is required to enable rounding and the last two stages of normalization may be performed during exponent computation for a reduced critical path. Also, the circuit provides reconfigurability to support FPMAC operation (e.g., for FP16/BF16) and FP accumulation (e.g., for FP32).

Example FPMAC Operations

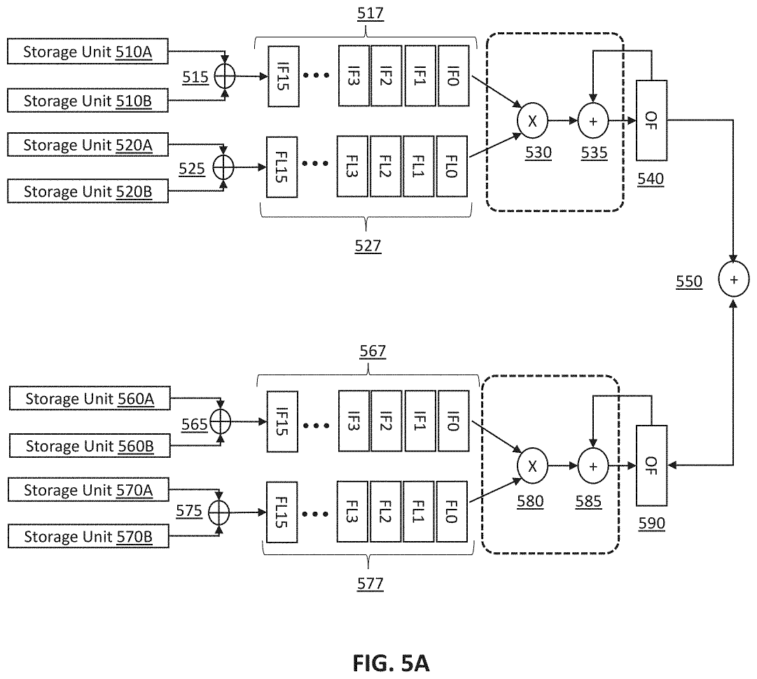

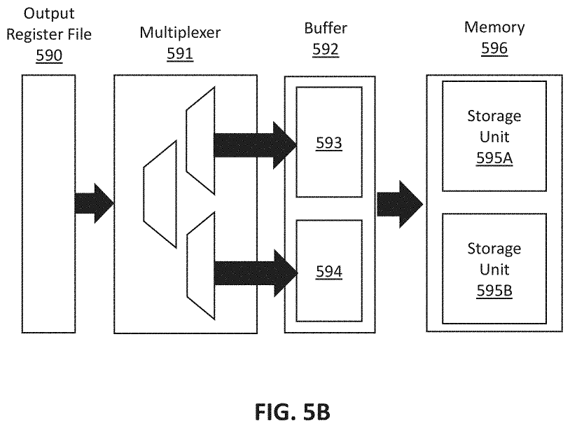

FIGS. 5A and 5B illustrate FPMAC operations, in accordance with various embodiments. The FPMAC operations are performed by two PEs. As shown in FIG. 5A, the first PE includes an input register file 517, a weight register file 527, a multiplier 530, an accumulator 535, and an output register file 540. The second PE includes an input register file 567, a weight register file 577, a multiplier 580, an accumulator 585, and an output register file 590. Each PE may be an embodiment of the PE 500 in FIG. 5A.

The first FPMAC operation, which is the FPMAC operation performed by the first PE, starts with storage units 510A, 510B, 520A, and 520B of a memory, such as a SRMA. An embodiment of the memory is the memory 210. The storage unit 510A stores a byte of an input operand. The storage unit 510B stores another byte of the input operand. The storage unit 520A stores a byte of a weight operand. The storage unit 520B stores another byte of the weight operand. The bytes in the storage units 510A and 510B are fed into a concatenating module 515, which links the two bytes and generates a sequence of 16 bits. The concatenating module 515 transfers the 16 bits into the input register file 517 where the 16 bits are stored sequentially. Similarly, the bytes in the storage units 520A and 520B are fed into a concatenating module 525, which links the two bytes and generates a sequence of 16 bits. The concatenating module 525 transfers the 16 bits into the weight register file 527 where the 16 bits are stored sequentially. In some embodiments, a bit is stored in a storage unit of the corresponding register file.

The bits in the input register file 517 and the weight register file 527 are fed sequentially into a multiplier 530, where the multiplier 530 performs a series of multiplication operations. Each multiplication operation is with a bit from the input register file 517 and a bit from the weight register file 527. The results of the multiplication operations are fed into an accumulator 535, which generates an individual partial sum of the first PE. The individual partial sum of the first PE can be stored in the output register file 540. The series of multiplication operations by the multiplier 530 and the accumulation operation by the accumulator 535 may constitute an FPMAC operation by the first PE. The accumulator 535 may operate with a different FP bit precision from the multiplier 530. In an example, the multiplier 530 performs multiplications with FP16 or BF16 format, but the accumulator 535 performs accumulations with FP32 format.

Similarly, the second PE performs an FPMAC operation with an input operand, which includes a byte stored in the storage unit 560A and another byte stored in the storage unit 560A, with a weight operand, which includes a byte stored in the storage unit 570A and another byte stored in the storage unit 570A. The storages units 560A, 560B, 570A, and 570B may be in the same memory as the storage units 510A, 510B, 520A, and 520B. The concatenating module 565 links the bytes of the input operand and saves the bits sequentially in the input register file 567. The concatenating module 575 links the bytes of the weight operand and saves the bits sequentially in the weight register file 577. In some embodiments, the concatenating module 515, 525, 565, or 575 is an embodiment of the concatenating module 240, or of a portion of the concatenating module 240. The multiplier 580 performs a series of multiplications by using the input operand and weight operand. The accumulator 585 performs an accumulation with results of the multiplications and generates an individual partial sum of the second PE. The accumulator 585 may with a different FP bit precision from the multiplier 580. In an example, the multiplier 580 performs multiplications with FP16 or BF16 format, but the accumulator 585 performs accumulations with FP32 format.

A FP adder 550 is fed with the individual partial sums of the two PEs and accumulates the individual partial sums, which results in an internal partial sum of the PE array where the two PEs are located. In some embodiments, the FP adder 550 is in one of the PEs. For instance, the second PE may be subsequent to the first PE along a data path in the PE array, and the FP adder 550 is in the second PE and the internal partial sum is stored in the output register file 590 of the second PE. The FP adder 550 may operate with the same FP bit precision or FP format as the accumulator 535 or 585.

As shown in FIG. 5B, the internal partial sum stored in the output register file 590 is fed into a multiplexer 591, where the internal partial sum is divided into two portions 593 and 594. The two portions are stored in separate storage units of a buffer 592, respectively. The buffer 592 may be an embodiment of the buffer 320. Further, the two portions are transferred to storage units 595A and 595B, respectively, of a memory 596. The memory 596 may be an embodiment of the memory 210. The process in FIG. 5B may be a drain operation associated with the second PE, or with the PE column.

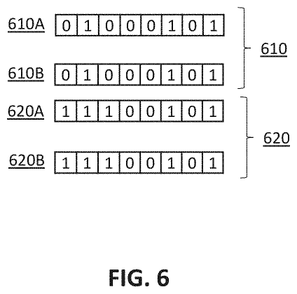

FIG. 6 illustrates an input operand 610 and a weight operand 620 that are encoded with a sparsity logic, in accordance with various embodiments. The input operand 610 includes an upper portion 610A and a lower portion 610B. The weight operand 620 includes an upper portion 620A and a lower portion 620B are the and the lower portion. In the embodiment of FIG. 6, each operand is in an FP16 or BF16 format and therefore has 16 bits. Each portion has eight bits, i.e., a byte. In other embodiments, the input operand 610 and weight operand 620 may have different FP formats.

As show in FIG. 6, the upper portion 610A and lower portion 610B of the input operand 610 have the same bitmap: i.e., the upper portion 610A has the same bits arranged in the same sequence as the lower portion 610B. Similarly, the upper portion 620A and lower portion 620B of the weight operand 620 have the same bitmap the upper portion 620A has the same bits arranged in the same sequence as the lower portion 620B. That is because the upper portion 610A and lower portion 610B are encoded with a sparsity logic, e.g., find-first sparsity logic. In a process of zero value suppression, the upper portion and lower portion of an operand are not independently encoded. For instance, during a process of encoding an operand, a zero is assigned to a portion of the operand when both portions are zero, i.e., when the entire operand is zero. When the operand is not zero, positions of bits in the operand may be rearranged to generate identical bitmaps of the two portions. For instance, one or more bits in the operand may be repositioned in the operand, i.e., the ranks of these bits are changed. This ensures that the bitmaps of the two portions are the same. This can enable the sparsity logic also work with different bit precisions, such as INT8, without any addition circuit. Thus, FPMAC units provide more flexibility with respect to bit precision and is more efficient.

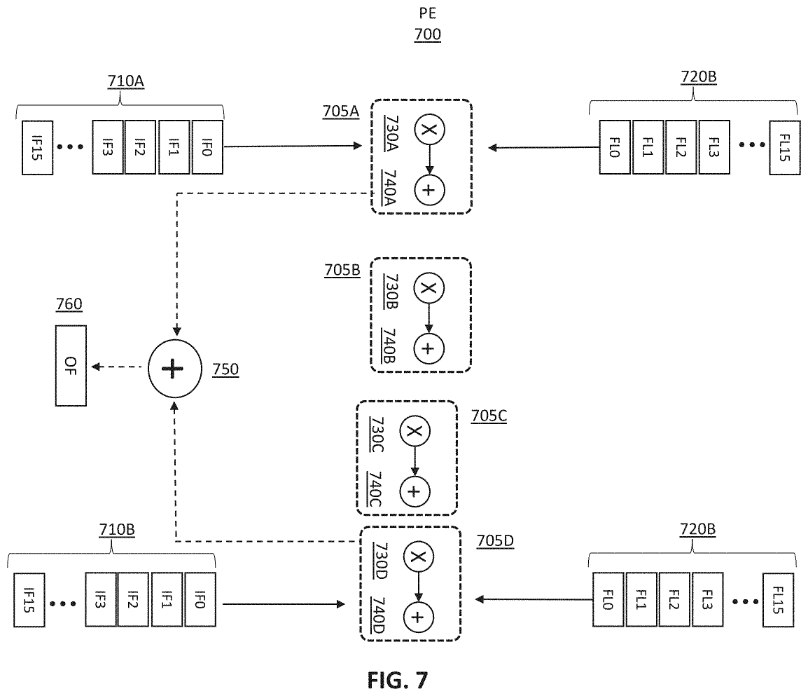

FIG. 7 illustrates vector-vector FPMAC operations by a PE 700, in accordance with various embodiments. The PE 700 may be an embodiment of the PE 400. The PE 700 includes two input register files 710A and 710B (collectively referred to as “input register files 710” or “input register file 710”), two weight register files 720A and 720B (collectively referred to as “weight register files 720” or “weight register file 720”), four FPMAC units 705A-D (collectively referred to as “FPMAC units 705” or “FPMAC unit 705”), four multipliers 730A-D (collectively referred to as “multipliers 730” or “multipliers 730”), four accumulators 740A-D (collectively referred to as “accumulators 740” or “accumulators 740”), an FP adder 750, and an output register file 760. Each FPMAC unit 705 includes a multiplier 730 and an accumulator 740. In some embodiments, the PE 700 may include more, fewer, or different components. For instance, the PE 700 may include a different number of input register file, weight register file, or output register file.

An input register file 710 may be an embodiment of the input register file 410. The input register file 710A stores a sequence of input channels IF0-IF15. The input channels IF0-IF15 are an input operand. The input register file 710B stores another sequence of input channels IF0-IF15 (collectively referred to as “IFs” or “IF”), which are another input operand. A weight register file 720 may be an embodiment of the weight register file 420. The weight register file 720A stores a sequence of bits FL0-FL15 (collectively referred to as “FLs” or “FL”), which are a weight operand. The weight register file 720B stores another sequence of bits FL0-FL15, which are another weight operand.

In the embodiment of FIG. 7, each operand is considered as a vector, e.g., a vector of 16 bits. FIG. 7 shows two vector-vector FPMAC operation: one based on the input operand in the input register file 710A and the weight operand in the weight register file 720A, and the other one based on the input operand in the input register file 710B and the weight operand in the weight register file 720B. In the first vector-vector FPMAC operation, the input operand in the input register file 710A and the weight operand in the weight register file 720A are fed into the multiplier 730A. The multiplier 730A performs a series of multiplications, each of which is a multiplication of an IF with an FL. The accumulator 740A performs an accumulation of the results of the multiplications and generates a first sum.

In the second vector-vector FPMAC operation, the input operand in the input register file 710B and the weight operand in the weight register file 720B are fed into the multiplier 730B. The multiplier 730B performs a series of multiplications, each of which is a multiplication of an IF with an FL. The accumulator 740B performs an accumulation of the results of the multiplications from the multiplier 730B and generates a second sum.

In FIG. 7, the FPMAC units 705B and 705C are not used in the two vector-vector operations. In some embodiments, the PE 700 may not include these units. In other embodiments, the PE 700 may perform additional vector-vector operations by using the FPMAC unit 705B or 705C. In some embodiments, the multipliers 730 perform multiplication based on FP16 or BF16 format. The accumulators 740 perform accumulations based on FP32 format. A multiplier 730 may be the multiplier 450. An accumulator 740 may be an embodiment of the accumulator 460.

The first sum and the second sum are fed into the FP adder 750. The FP adder 750 accumulates the first sum and the second sum and generates a total sum of the vector-vector FPMAC operation. The total sum is stored in the output register file 760 of the PE 700. The FP adder 750 may perform accumulations based on FP32 format. The FP adder 750 may be an embodiment of the FP adder 470. In some embodiments, the FP adder 750 may be one of the accumulators 740.

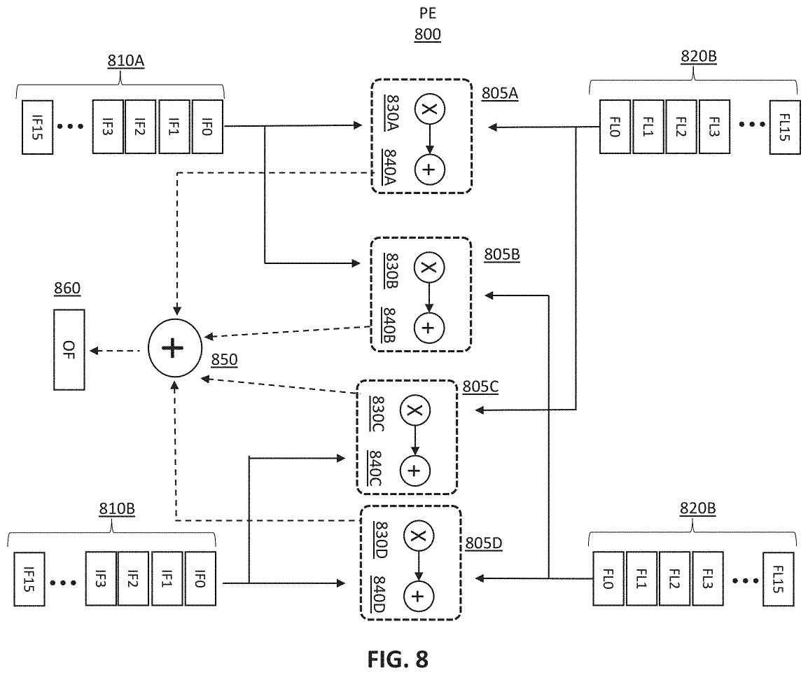

FIG. 8 illustrates a matrix-matrix FPMAC operation by a PE 800, in accordance with various embodiments. The PE 800 may be an embodiment of the PE 400. The PE 800 includes two input register files 810A and 810B (collectively referred to as “input register files 810” or “input register file 810”), two weight register files 820A and 820B (collectively referred to as “weight register files 820” or “weight register file 820”), four FPMAC units 805A-D (collectively referred to as “FPMAC units 805” or “FPMAC unit 805”), four multipliers 830A-D (collectively referred to as “multipliers 830” or “multipliers 830”), four accumulators 840A-D (collectively referred to as “accumulators 840” or “accumulators 840”), an FP adder 850, and an output register file 860. Each FPMAC unit 805 includes a multiplier 830 and an accumulator 840. In some embodiments, the PE 800 may include more, fewer, or different components. For instance, the PE 800 may include a different number of input register file, weight register file, or output register file.

An input register file 810 may be an embodiment of the input register file 410. The input register file 810A stores a sequence of input channels IF0-IF15. The input channels IF0-IF15 are an input operand. The input register file 810B stores another sequence of input channels IF0-IF15 (collectively referred to as “IFs” or “IF”), which are another input operand. A weight register file 820 may be an embodiment of the weight register file 420. The weight register file 820A stores a sequence of bits FL0-FL15 (collectively referred to as “FLs” or “FL”), which are a weight operand. The weight register file 820B stores another sequence of bits FL0-FL15, which are another weight operand.

In the embodiment of FIG. 8, each operand is considered as a vector, e.g., a vector of 16 bits. FIG. 8 shows a matrix-matrix FPMAC operation based on the four operands. It may be considered that the two input operands constitute an input matrix, and the two weight operands constitute a weight matrix. The matrix-matrix FPMAC operation includes four vector-vector FPMAC operations. Each pair of a multiplier 830 and an accumulator 840 performs one of the four vector-vector FPMAC operations.

As shown in FIG. 8, the input operand in the input register file 810A and the weight operand in the weight register file 820A are fed into the FPMAC unit 805A. The multiplier 830A performs a series of multiplications, each of which is a multiplication of an IF with an FL. The accumulator 840A performs an accumulation of the results of the multiplications and generates a first sum. Similarly, the input operand in the input register file 810A and the weight operand in the weight register file 820B are fed into the FPMAC unit 805B. The multiplier 830B performs a series of multiplications, then the accumulator 840B performs an accumulation of the results of the multiplications and generates a second sum. Also, the input operand in the input register file 810B and the weight operand in the weight register file 820A are fed into the FPMAC unit 805C. The multiplier 830C performs a series of multiplications, then the accumulator 840C performs an accumulation of the results of the multiplications and generates a third sum. Further, the input operand in the input register file 810B and the weight operand in the weight register file 820B are fed into the FPMAC unit 805D. The multiplier 830D performs a series of multiplications, then the accumulator 840D performs an accumulation of the results of the multiplications and generates a fourth sum.

The four sums are fed into the FP adder 850. The FP adder 850 accumulates the four sums and generates a total sum of the matrix-matrix FPMAC operation. In other embodiments, the addition of the four sums may be performed by an accumulator 840 in one of the FPMAC units 805. The total sum is stored in the output register file 860.

In some embodiments, the multipliers 830 perform multiplication based on FP16 or BF16 format. The accumulators 840 and FP adder 850 perform accumulations based on FP32 format. A multiplier 830 may be the multiplier 450. An accumulator 840 may be an embodiment of the accumulator 460. The FP adder 850 may be an embodiment of the FP adder 470. In some embodiments, the FP adder 750 may be one of the accumulators 840.

Each matrix in FIG. 8 includes two vectors. In other embodiments, a matrix in a matrix-matrix FPMAC operation may include more vectors, such as three, four, five, and so on. Even though not show in FIG. 7 or FIG. 8, a PE including multiple FPMAC units can be used to perform vector-matrix or matrix-vector FPMAC operations. For instance, a first pair of multiplier and accumulation unit can perform an FPMAC operation based on a first input operand and a weight operand, and a second pair of multiplier and accumulation unit can perform an FPMAC operation based on a second input operand and a weight operand. As another example, a first pair of multiplier and accumulation unit can perform an FPMAC operation based on an input operand and a first weight operand, and a second pair of multiplier and accumulation unit can perform an FPMAC operation based on the input operand and a second weight operand

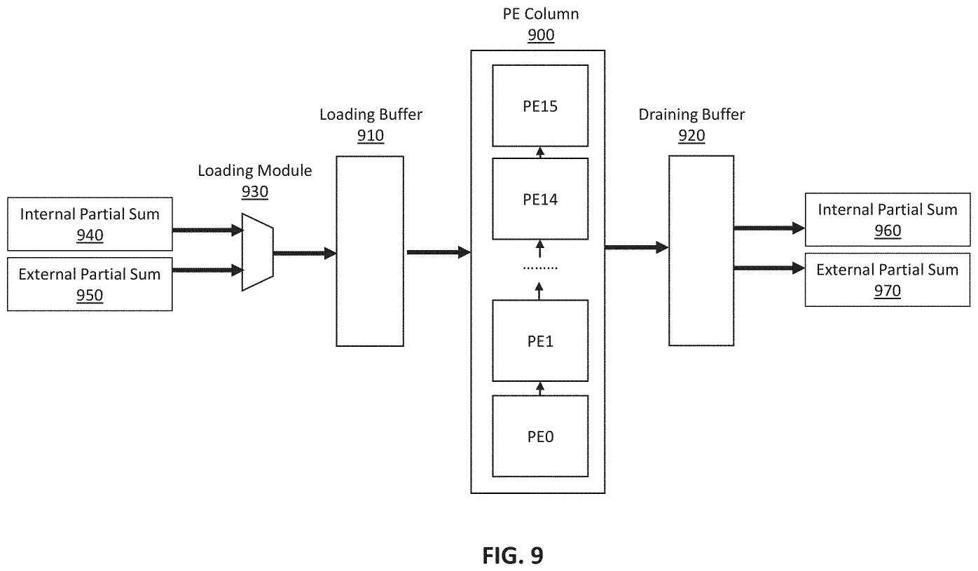

FIG. 9 illustrates a partial sum accumulation operation within a PE column 900, in accordance with various embodiments. The partial sum accumulation includes an internal partial sum accumulation and an external partial sum accumulation. The PE column 900 may be an embodiment of a PE column 305 in FIG. 3. In the embodiment of FIG. 9, the PE column 900 include 16 PEs: PE0-15, which are arranged sequentially. The PE column 900 is coupled to a loading buffer 910 and a draining buffer 920. In some embodiments, the loading buffer 910 and draining buffer 920 may be a single buffer, such as the buffer 320. The loading buffer 910 receives from a loading module 930 an internal partial sum 940 and an external partial sum.

The internal partial sum 940 may be an output of another PE column, e.g., a PE column that is arranged before the PE column 900 in a PE array. The internal partial sum 940 may be stored temporarily in the loading buffer 910 before it is fed to the PE column 900. The PE column 900 performs the internal partial sum accumulation based on the internal partial sum 940. In an example, a PE (e.g., PE15) in the PE column 900 accumulates the internal partial sum 940 with an internal partial sum of the PE column 900 and generates a new internal partial sum 960. The internal partial sum of the PE column 900 may be a sum of individual partial sums of all the PEs inside the PE column 900.

In another example, the internal partial sum 940 is fed into PE0, which performs an accumulation of the internal partial sum 940 with an individual partial sum of PE0 to generate an output of PE0. The output of PE0 is fed into the next PE, i.e., PE1, and PE1 performs an accumulation of the output of PE0 with individual partial sum of PE1 to generate an output of PE1. This process continues until PE15 outputs the internal partial sum 960. The internal partial sum 960 can be loaded from the PE column 900 to the draining buffer 920. In some embodiments, after being temporarily stored in the draining buffer 920, the internal partial sum 960 may be fed into the next PE column in the PE array.

In some embodiments, the external partial sum 950 may be an output of a different PE array from the PE array where the PE column 900 is located. In other embodiments, the external partial sum 950 may be an output from the same PE array where the PE column 900 is located, and the external partial sum 950 may be an internal partial sum of the PE array that was drained out in an earlier round. The external partial sum 950 may be stored temporarily in the loading buffer 910 before it is fed to the PE column 900. The PE column 900 may perform an external partial sum accumulation based on the external partial sum 950. In some embodiments, a PE (e.g., PE15) in the PE column 900 may accumulate the internal partial sum 960 with external partial sum 950 and generates a new external partial sum 970. In other embodiments, the external partial sum 950 is fed into PE0, which performs an accumulation of the external partial sum 950 with an individual partial sum of PE0 to generate an output of PE0. In some embodiments, an output of PE0 can be directly drained out, e.g., from the PE array where PE0. In other embodiments, an output of PE0 is fed into the next PE in the PE array, i.e., PE1, and PE1 performs an accumulation of the output of PE0 with individual partial sum of PE1 to generate an output of PE1. This process continues until PE15 outputs either an output point or an external partial sum 970. The external partial sum 970 can be loaded from the PE column 900 to the draining buffer 920. In some embodiments, after being temporarily stored in the draining buffer 920, the external partial sum 970 may be fed into the next PE column in the PE array. In other embodiments, the PE column 900 may be the last column in the PE array and the external partial sum 970 may be fed into another PE array for further external partial sum accumulation. Alternatively, the external partial sum 970 may be used as an output of the DNN layer and be fed into the next layer in the DNN.

Example DL Environment

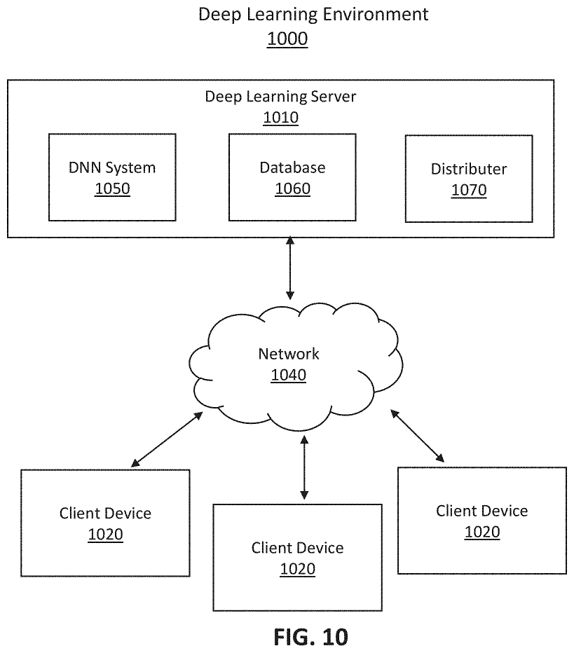

FIG. 10 illustrates a DL environment 1000, in accordance with various embodiments. The DL environment 1000 includes a DL server 1010 and a plurality of client devices 1020 (individually referred to as client device 1020). The DL server 1010 is connected to the client devices 1020 through a network 1040. In other embodiments, the DL environment 1000 may include fewer, more, or different components.

The DL server 1010 trains DL models using neural networks. A neural network is structured like the human brain and consists of artificial neurons, also known as nodes. These nodes are stacked next to each other in three types of layers: input layer, hidden layer(s), and output layer. Data provides each node with information in the form of inputs. The node multiplies the inputs with random weights, calculates them, and adds a bias. Finally, nonlinear functions, also known as activation functions, are applied to determine which neuron to fire. The DL server 1010 can use various types of neural networks, such as DNN, recurrent neural network (RNN), generative adversarial network (GAN), long short-term memory network (LSTMN), and so on. During the process of training the DL models, the neural networks use unknown elements in the input distribution to extract features, group objects, and discover useful data patterns. The DL models can be used to solve various problems, e.g., making predictions, classifying images, and so on. The DL server 1010 may build DL models specific to particular types of problems that need to be solved. A DL model is trained to receive an input and outputs the solution to the particular problem.

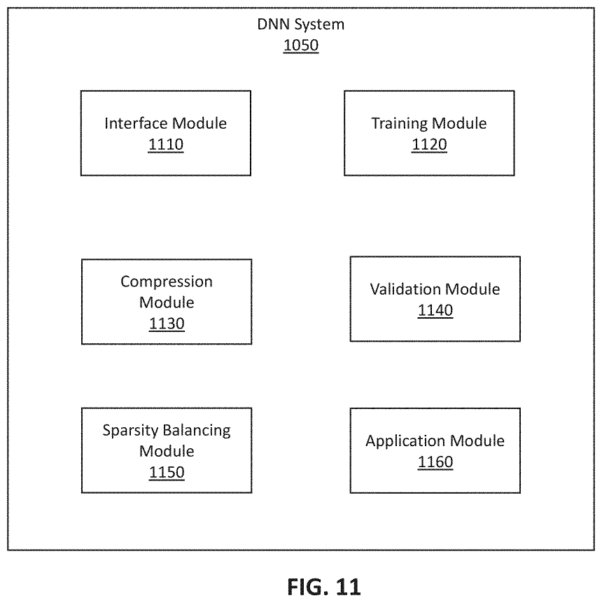

In FIG. 10, the DL server 1010 includes a DNN system 1050, a database 1060, and a distributer 1070. The DNN system 1050 trains DNNs. The DNNs can be used to process images, e.g., images captured by autonomous vehicles, medical devices, satellites, and so on. In an embodiment, a DNN receives an input image and outputs classifications of objects in the input image. An example of the DNNs is the DNN 100 described above in conjunction with FIG. 1. The DNN system 1050 also compresses the trained DNNs to reduce the sizes of the trained DNNs. As the compressed DNNs has a smaller size, application of the compressed DNNs requires less time and computing resources (e.g., memory, processor, etc.) compared with uncompressed DNNs. The compressed DNNs may be used on low memory systems, like mobile phones, IOT edge devices, and so on. The DNN system 1050 can also rearrange weight operands and activation operands in a trained or compressed DNN to balance sparsity in the weight operands and activation operands. More details regarding the DNN system 1050 are described below in conjunction with FIG. 11.

The database 1060 stores data received, used, generated, or otherwise associated with the DL server 1010. For example, the database 1060 stores a training dataset that the DNN system 1050 uses to train DNNs. In an embodiment, the training dataset is an image gallery that can be used to train a DNN for classifying images. The training dataset may include data received from the client devices 1020. As another example, the database 1060 stores hyperparameters of the neural networks built by the DL server 1010.

The distributer 1070 distributes DL models generated by the DL server 1010 to the client devices 1020. In some embodiments, the distributer 1070 receives a request for a DNN from a client device 1020 through the network 1040. The request may include a description of a problem that the client device 1020 needs to solve. The request may also include information of the client device 1020, such as information describing available computing resource on the client device. The information describing available computing resource on the client device 1020 can be information indicating network bandwidth, information indicating available memory size, information indicating processing power of the client device 1020, and so on. In an embodiment, the distributer may instruct the DNN system 1050 to generate a DNN in accordance with the request. The DNN system 1050 may generate a DNN based on the description of the problem. Alternatively or additionally, the DNN system 1050 may compress a DNN based on the information describing available computing resource on the client device.

In another embodiment, the distributer 1070 may select the DNN from a group of pre-existing DNNs based on the request. The distributer 1070 may select a DNN for a particular client device 1030 based on the size of the DNN and available resources of the client device 1030. In embodiments where the distributer 1070 determines that the client device 1030 has limited memory or processing power, the distributer 1070 may select a compressed DNN for the client device 1030, as opposed to an uncompressed DNN that has a larger size. The distributer 1070 then transmits the DNN generated or selected for the client device 1020 to the client device 1020.

In some embodiments, the distributer 1070 may receive feedback from the client device 1020. For example, the distributer 1070 receives new training data from the client device 1020 and may send the new training data to the DNN system 1050 for further training the DNN. As another example, the feedback includes an update of the available computer resource on the client device 1020. The distributer 1070 may send a different DNN to the client device 1020 based on the update. For instance, after receiving the feedback indicating that the computing resources of the client device 1020 have been reduced, the distributer 1070 sends a DNN of a smaller size to the client device 1020.

The client devices 1020 receive DNNs from the distributer 1070 and applies the DNNs to solve problems, e.g., to classify objects in images. In various embodiments, the client devices 1020 input images into the DNNs and uses the output of the DNNs for various applications, e.g., visual reconstruction, augmented reality, robot localization and navigation, medical diagnosis, weather prediction, and so on. A client device 1020 may be one or more computing devices capable of receiving user input as well as transmitting and/or receiving data via the network 1040. In one embodiment, a client device 1020 is a conventional computer system, such as a desktop or a laptop computer. Alternatively, a client device 1020 may be a device having computer functionality, such as a personal digital assistant (PDA), a mobile telephone, a smartphone, an autonomous vehicle, or another suitable device. A client device 1020 is configured to communicate via the network 1040. In one embodiment, a client device 1020 executes an application allowing a user of the client device 1020 to interact with the DL server 1010 (e.g., the distributer 1070 of the DL server 1010). The client device 1020 may request DNNs or send feedback to the distributer 1070 through the application. For example, a client device 1020 executes a browser application to enable interaction between the client device 1020 and the DL server 1010 via the network 1040. In another embodiment, a client device 1020 interacts with the DL server 1010 through an application programming interface (API) running on a native operating system of the client device 1020, such as IOS® or ANDROID™.

In an embodiment, a client device 1020 is an integrated computing device that operates as a standalone network-enabled device. For example, the client device 1020 includes display, speakers, microphone, camera, and input device. In another embodiment, a client device 1020 is a computing device for coupling to an external media device such as a television or other external display and/or audio output system. In this embodiment, the client device 1020 may couple to the external media device via a wireless interface or wired interface (e.g., an HDMI cable) and may utilize various functions of the external media device such as its display, speakers, microphone, camera, and input devices. Here, the client device 1020 may be configured to be compatible with a generic external media device that does not have specialized software, firmware, or hardware specifically for interacting with the client device 1020.

The network 1040 supports communications between the DL server 1010 and client devices 1020. The network 1040 may comprise any combination of local area and/or wide area networks, using both wired and/or wireless communication systems. In one embodiment, the network 1040 may use standard communications technologies and/or protocols. For example, the network 1040 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 1040 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 1040 may be represented using any suitable format, such as hypertext markup language (HTML) or extensible markup language (XML). In some embodiments, all or some of the communication links of the network 1040 may be encrypted using any suitable technique or techniques.

Example DNN System

FIG. 11 is a block diagram of a DNN system 1100, in accordance with various embodiments. The DNN system 1100 may be an embodiment of the DNN system 1050 or the DNN accelerator 200. The DNN system 1100 trains DNNs. The DNN system 1100 can train DNNs that can be used to solve various problems, such as image classification, learning relationships between biological cells (e.g., DNA, proteins, etc.), control behaviors for devices (e.g., robots, machines, etc.), and so on. The DNN system 1100 includes an interface module 1110, a training module 1120, a compression module 1130, a validation module 1140, and an application module 1150. In other embodiments, alternative configurations, different or additional components may be included in the DNN system 1100. Further, functionality attributed to a component of the DNN system 1100 may be accomplished by a different component included in the DNN system 1100.

The interface module 1110 facilitates communications of the DNN system 1100 with other systems. For example, the interface module 1110 establishes communications between the DNN system 1100 with an external database to receive data that can be used to train DNNs or input into DNNs to perform tasks. As another example, the interface module 1110 supports the DNN system 1100 to distribute DNNs to other systems, e.g., computing devices configured to apply DNNs to perform tasks.

The training module 1120 trains DNNs by using a training dataset. The training module 1120 forms the training dataset. In an embodiment where the training module 1120 trains a DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a tuning subset used by the compression module 1130 to tune a compressed DNN or as a validation subset used by the validation module 1140 to validate performance of a trained or compressed DNN. The portion of the training dataset not including the tuning subset and the validation subset may be used to train the DNN.

The training module 1120 also determines hyperparameters for training the DNN. Hyperparameters are variables specifying the DNN training process. Hyperparameters are different from parameters inside the DNN (e.g., weights of weight operands). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the DL algorithm works through the entire training dataset. One epoch means that each training sample in the training dataset has had an opportunity to update the parameters inside the DNN. An epoch may include one or more batches. The number of epochs may be 10, 100, 500, 1000, or even larger.

The training module 1120 defines the architecture of the DNN, e.g., based on some of the hyperparameters. The architecture of the DNN includes an input layer, an output layer, and a plurality of hidden layers. The input layer of a DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as rectified liner unit (ReLU) layers, pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

The training module 1120 inputs the training dataset into the DNN and modifies the parameters inside the DNN to minimize the error between the generated labels of objects in the training images and the training labels. The parameters include weights of weight operands in the convolutional layers of the DNN. In some embodiments, the training module 1120 uses a cost function to minimize the error. After the training module 1120 finishes the predetermined number of epochs, the training module 1120 may stop updating the parameters in the DNN. The DNN having the updated parameters is referred to as a trained DNN.

The compression module 1130 compresses trained DNNs to reduce complexity of the trained DNNs at the cost of small loss in model accuracy. The compression module 1130 converts some or all of the convolutional tensors in a trained DNN into reduced tensors that have reduced dimensions from the corresponding convolutional tensors. The compression module 1130 then integrates the reduced tensors into the trained DNN to reduce the complexity of the trained DNN. In some embodiments, the compression module 1130 prunes a subset of the weight operands in a convolutional layer to generate a sparse tensor and then decomposes the sparse tensor to generate the reduced tensor of the convolutional layer. The compression module 1130 compresses the trained DNN by removing the convolutional tensor from the network and placing the reduced tensor into the network. After some or all of the convolutional tensor in the trained DNN is removed and their reduced tensors are integrated, a compressed DNN is generated. The compression module 1130 may fine-tune the compressed DNN. For instance, the compression module 1130 uses the training dataset, or a subset of the training dataset, to train the compressed DNN. As the compressed DNN is converted from the pre-trained DNN, the fine-tuning process is a re-training process.

The validation module 1140 verifies accuracy of trained or compressed DNN. In some embodiments, the validation module 1140 inputs samples in a validation dataset into the DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 1140 determines may determine an accuracy score measuring the bit precision, recall, or a combination of bit precision and recall of the DNN. The validation module 1140 may use the following metrics to determine the accuracy score: Bit precision=TP/(TP+FP) and Recall=TP/(TP+FN), where bit precision may be how many the reference classification model correctly predicted (TP or true positives) out of the total it predicted (TP+FP or false positives), and recall may be how many the reference classification model correctly predicted (TP) out of the total number of objects that did have the property in question (TP+FN or false negatives). The F-score (F-score=2*PR/(P+R)) unifies bit precision and recall into a single measure.

The validation module 1140 may compare the accuracy score with a threshold score. In an example where the validation module 1140 determines that the accuracy score of the augmented model is lower than the threshold score, the validation module 1140 instructs the training module 1120 or the compression module 1130 to re-train the DNN. In one embodiment, the training module 1120 or the compression module 1130 may iteratively re-train the DNN until the occurrence of a stopping condition, such as the accuracy measurement indication that the DNN may be sufficiently accurate, or a number of training rounds having taken place.

In some embodiments, the validation module 1140 instructs the compression module 1130 to compress DNNs. For example, the validation module 1140 may determine whether an accuracy score of a compressed DNN is above a threshold score. In response to determining that the accuracy score of a compressed DNN is above a threshold score, the validation module 1140 instructs the compression module 1130 to further compress the DNN, e.g., by compressing an uncompressed convolutional layer in the DNN. In an embodiment, the validation module 1140 may determine a compression rate based on the accuracy score and instructs the compression module 1130 to further compress the DNN based on the compression rate. The compression rate, e.g., is a percentage indicating the reduced size of the DNN from compression.

The application module 1150 applies the trained or compressed DNN to perform tasks. For instance, the application module 1150 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like.

Example Method of FPMAC Operation

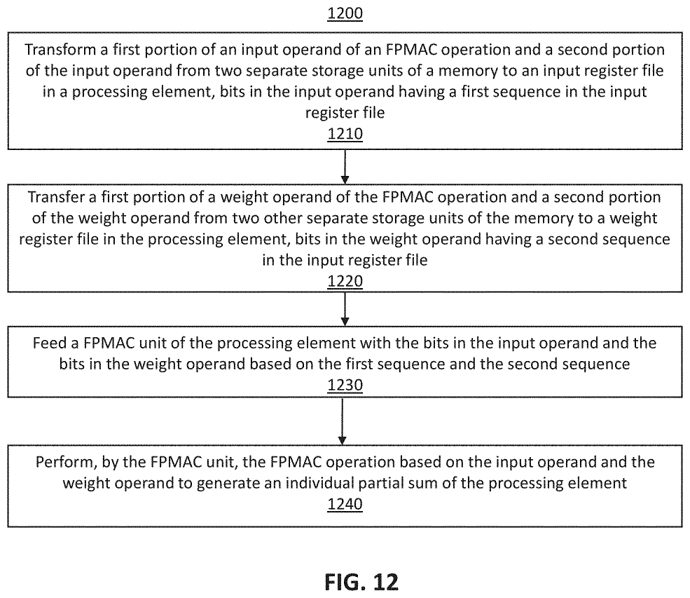

FIG. 12 is a flowchart showing a method 1200 for an FPMAC operation, in accordance with various embodiments. The method 1200 may be performed by the DNN accelerator 200 in FIG. 2. Although the method 1200 is described with reference to the flowchart illustrated in FIG. 12, many other methods for FPMAC operations may alternatively be used. For example, the order of execution of the steps in FIG. 12 may be changed. As another example, some of the steps may be changed, eliminated, or combined.

The DNN accelerator 200 transfers 1210 a first portion of an input operand of a floating-point multiply-accumulate (FPMAC) operation and a second portion of the input operand from two separate storage units of a memory to an input register file in a processing element. Bits in the input operand have a first sequence in the input register file. In some embodiments, the first portion of the input operand includes a first half of the bits in the first sequence, and the second portion of the input operand includes a second half of the bits in the first sequence. The first portion and the second portion of the input operand have same bits arranged in a same sequence.

The DNN accelerator 200 also transfers 1220 a first portion of a weight operand of the FPMAC operation and a second portion of the weight operand from two other separate storage units of the memory to a weight register file in the processing element. Bits in the weight operand have a second sequence in the input register file. In some embodiments, the first portion of the weight operand includes a first half of the bits in the second sequence, and the second portion of the weight operand includes a second half of the bits in the second sequence. The first portion and the second portion of the weight operand have same bits arranged in a same sequence.

The DNN accelerator 200 feeds 1230 an FPMAC unit of the processing element with the bits in the input operand and the bits in the weight operand based on the first sequence and the second sequence. For instance, the bits in the input operand may be transferred from the input register file to the FPMAC unit in accordance with the first sequence. The bits in the weight operand may be transferred from the weight register file to the FPMAC unit in accordance with the second sequence.

The DNN accelerator 200 performs 1240, by the FPMAC unit, the FPMAC operation based on the input operand and the weight operand to generate an individual partial sum of the processing element. The individual partial sum is a result of the FPMAC operation. In some embodiments, the DNN accelerator 200 performs a series of multiplications operations. Each multiplication operation includes multiplying a first bit in the first sequence with a second bit in the second sequence. A rank of the first bit in the first sequence equals a rank of the second bit in the second sequence. The individual partial sum may have a different bit precision from the input operand or the weight operand. The DNN accelerator 200 may further accumulate the individual partial sum and an output of another processing element to generate an internal partial sum. The internal partial sum may have a same bit precision as the individual partial sum.

In some embodiments, the input operand and the weight operand are vectors, and the FPMAC operation is a vector-vector FPMAC operations. In some embodiments, the input operand is a first input operand of an input matrix. The input matrix also includes a second input operand. The weight operand is a first weight operand of a weight matrix. The weight matrix also includes a second weight operand. The DNN accelerator 200 may perform a matrix-matrix FPMAC operation based on the input matrix and the weight matrix. For instance, the FPMAC unit may be a first FPMAC unit of the processing element and the FPMAC operation is a first FPMAC operation by the processing element. The DNN accelerator 200 may perform, by a second FPMAC unit of the processing element, a second FPMAC operation with the first input operand and the second weight operand. The DNN accelerator 200 may also perform, by a third FPMAC unit of the processing element, a third FPMAC operation with the second input operand and the first weight operand. The DNN accelerator 200 may further perform, by a fourth FPMAC unit of the processing element, a fourth FPMAC operation with the second input operand and the second weight operand.

Example Computing Device

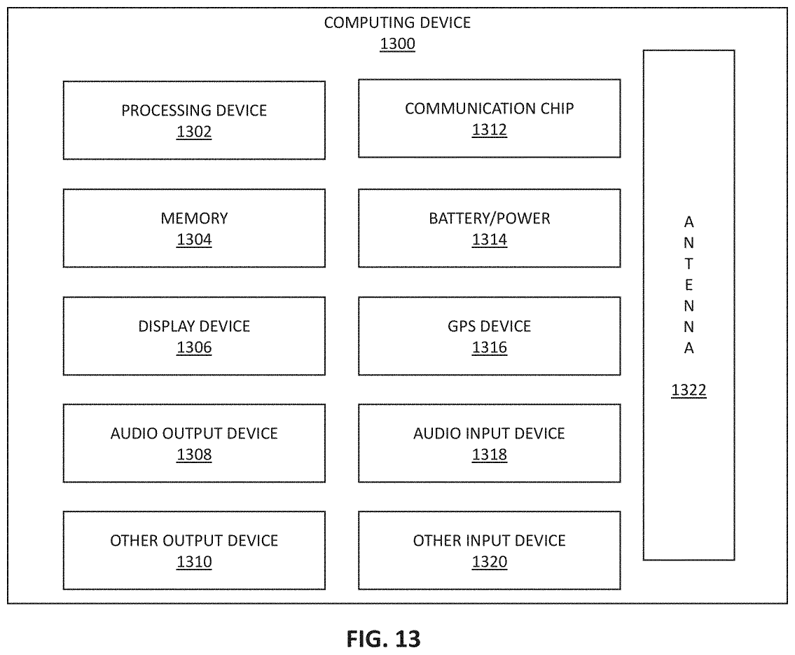

FIG. 13 is a block diagram of an example computing device 1300, in accordance with various embodiments. A number of components are illustrated in FIG. 13 as included in the computing device 1300, but any one or more of these components may be omitted or duplicated, as suitable for the application. In some embodiments, some or all of the components included in the computing device 1300 may be attached to one or more motherboards. In some embodiments, some or all of these components are fabricated onto a single system on a chip (SoC) die. Additionally, in various embodiments, the computing device 1300 may not include one or more of the components illustrated in FIG. 13, but the computing device 1300 may include interface circuitry for coupling to the one or more components. For example, the computing device 1300 may not include a display device 1306, but may include display device interface circuitry (e.g., a connector and driver circuitry) to which a display device 1306 may be coupled. In another set of examples, the computing device 1300 may not include an audio input device 1318 or an audio output device 1308, but may include audio input or output device interface circuitry (e.g., connectors and supporting circuitry) to which an audio input device 1318 or audio output device 1308 may be coupled.

The computing device 1300 may include a processing device 1302 (e.g., one or more processing devices). As used herein, the term “processing device” or “processor” may refer to any device or portion of a device that processes electronic data from registers and/or memory to transform that electronic data into other electronic data that may be stored in registers and/or memory. The processing device 1302 may include one or more digital signal processors (DSPs), application-specific ICs (ASICs), central processing units (CPUs), graphics processing units (GPUs), cryptoprocessors (specialized processors that execute cryptographic algorithms within hardware), server processors, or any other suitable processing devices. The computing device 1300 may include a memory 1304, which may itself include one or more memory devices such as volatile memory (e.g., DRAM), nonvolatile memory (e.g., read-only memory (ROM)), flash memory, solid state memory, and/or a hard drive. In some embodiments, the memory 1304 may include memory that shares a die with the processing device 1302. In some embodiments, the memory 1304 includes one or more non-transitory computer-readable media storing instructions executable to perform operations for balancing sparsity in weight operands, e.g., the method 1200 described above in conjunction with FIG. 12 or the operations performed by the DNN accelerator 200 described above in conjunction with FIG. 2. The instructions stored in the one or more non-transitory computer-readable media may be executed by the processing device 1302.

In some embodiments, the computing device 1300 may include a communication chip 1312 (e.g., one or more communication chips). For example, the communication chip 1312 may be configured for managing wireless communications for the transfer of data to and from the computing device 1300. The term “wireless” and its derivatives may be used to describe circuits, devices, DNN accelerators, methods, techniques, communications channels, etc., that may communicate data through the use of modulated electromagnetic radiation through a nonsolid medium. The term does not imply that the associated devices do not contain any wires, although in some embodiments they might not.

The communication chip 1312 may implement any of a number of wireless standards or protocols, including but not limited to Institute for Electrical and Electronic Engineers (IEEE) standards including Wi-Fi (IEEE 802.13 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication chip 1312 may operate in accordance with a Global system for Mobile Communication (GSM), General Packet Radio Service (GPRS), Universal Mobile Telecommunications system (UMTS), High Speed Packet Access (HSPA), Evolved HSPA (E-HSPA), or LTE network. The communication chip 1312 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1312 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1312 may operate in accordance with other wireless protocols in other embodiments. The computing device 1300 may include an antenna 1322 to facilitate wireless communications and/or to receive other wireless communications (such as AM or FM radio transmissions).

In some embodiments, the communication chip 1312 may manage wired communications, such as electrical, optical, or any other suitable communication protocols (e.g., the Ethernet). As noted above, the communication chip 1312 may include multiple communication chips. For instance, a first communication chip 1312 may be dedicated to shorter-range wireless communications such as Wi-Fi or Bluetooth, and a second communication chip 1312 may be dedicated to longer-range wireless communications such as global positioning system (GPS), EDGE, GPRS, CDMA, WiMAX, LTE, EV-DO, or others. In some embodiments, a first communication chip 1312 may be dedicated to wireless communications, and a second communication chip 1312 may be dedicated to wired communications.

The computing device 1300 may include battery/power circuitry 1314. The battery/power circuitry 1314 may include one or more energy storage devices (e.g., batteries or capacitors) and/or circuitry for coupling components of the computing device 1300 to an energy source separate from the computing device 1300 (e.g., AC line power).

The computing device 1300 may include a display device 1306 (or corresponding interface circuitry, as discussed above). The display device 1306 may include any visual indicators, such as a heads-up display, a computer monitor, a projector, a touchscreen display, a liquid crystal display (LCD), a light-emitting diode display, or a flat panel display, for example.

The computing device 1300 may include an audio output device 1308 (or corresponding interface circuitry, as discussed above). The audio output device 1308 may include any device that generates an audible indicator, such as speakers, headsets, or earbuds, for example.

The computing device 1300 may include an audio input device 1318 (or corresponding interface circuitry, as discussed above). The audio input device 1318 may include any device that generates a signal representative of a sound, such as microphones, microphone arrays, or digital instruments (e.g., instruments having a musical instrument digital interface (MIDI) output).

The computing device 1300 may include a GPS device 1316 (or corresponding interface circuitry, as discussed above). The GPS device 1316 may be in communication with a satellite-based system and may receive a location of the computing device 1300, as known in the art.

The computing device 1300 may include an other output device 1313 (or corresponding interface circuitry, as discussed above). Examples of the other output device 1313 may include an audio codec, a video codec, a printer, a wired or wireless transmitter for providing information to other devices, or an additional storage device.

The computing device 1300 may include an other input device 1320 (or corresponding interface circuitry, as discussed above). Examples of the other input device 1320 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1300 may have any desired form factor, such as a handheld or mobile computing system (e.g., a cell phone, a smart phone, a mobile internet device, a music player, a tablet computer, a laptop computer, a netbook computer, an ultrabook computer, a PDA, an ultramobile personal computer, etc.), a desktop computing system, a server or other networked computing component, a printer, a scanner, a monitor, a set-top box, an entertainment control unit, a vehicle control unit, a digital camera, a digital video recorder, or a wearable computing system. In some embodiments, the computing device 1300 may be any other electronic device that processes data.

### Select Examples

The following paragraphs provide various examples of the embodiments disclosed herein.

Example 1 provides an apparatus for a deep neural network (DNN) includes a concatenating module configured to generate an input operand of a floating-point multiply-accumulate (FPMAC) operation, the input operand including a plurality of bits, where a first portion of the input operand is stored in a first storage unit of a memory, and a second portion of the input operand is stored in a second storage unit of the memory; and a processing element including a register file configured to store the input operand by storing the plurality of bits in a sequence, a multiplier configured to perform a series of multiplication operations with the plurality of bits based on the sequence, where each multiplication operation is with one of the plurality of bits, and an accumulator configured to perform an accumulation operation with results of the series of multiplication operations and to generate an individual partial sum of the processing element.

Example 2 provides the apparatus of example 1, where the processing element further includes an adder that is configured to perform an accumulation operation with the individual partial sum of the processing element and an output of an additional processing element and to generate an internal partial sum, and the processing element and the additional processing element are arranged in a same PE array.

Example 3 provides the apparatus of example 2, where the adder is further configured to perform an accumulation operation with the internal partial sum and an external partial sum, and the external partial sum is an output of a different PE array.

Example 4 provides the apparatus of example 2, where a bit precision of the results of the series of multiplication operations is different from a bit precision of the internal partial sum.

Example 5 provides the apparatus of example 1, where the multiplier and the accumulator are in an electronic circuit that is configured to perform the series of multiplication operations and the accumulation operation.

Example 6 provides the apparatus of example 5, where the electronic circuit is configured to accumulate a first floating-point number with a second floating-point number by changing a first exponent in the first floating-point number based on a second exponent in the second floating-point number before determining whether the second exponent is larger than the first exponent.

Example 7 provides the apparatus of example 5, where the electronic circuit is configured to accumulate a first floating-point number with a second floating-point number, the first path in the electronic circuit is configured to adjust a first exponent in the first floating-point number based on a second exponent in the second floating-point number, Example the second path in the electronic circuit is configured to remove one or more bits having zero values from the first floating-point number or the second floating-point number, and Example the second path is separate from the first path.

Example 8 provides the apparatus of example 1, where the concatenating module is further configured to generate a weight operand of the FPMAC operation, the weight operand including a plurality of bits, a first portion of the weight operand is stored in a second storage unit of the memory, a second portion of the weight operand is stored in a third storage unit of the memory, and where a multiplication operation in the series is with a bit of the input operand and a bit of the weight operand

Example 9 provides the apparatus of example 1, where the first portion and the second portion include same bits arranged in a same sequence.

Example 10 provides the apparatus of example 1, where the input operand is a first input operand, the multiplier and the accumulator constitute a first FPMAC unit of the processing element, the processing element further includes a second FPMAC unit, a third FPMAC unit, and a fourth FPMAC unit, the first FPMAC unit is configured to perform an FPMAC operation with the first input operand and a first weight operand, the second FPMAC unit is configured to perform an FPMAC operation with the first input operand and a second weight operand, the third FPMAC unit is configured to perform an FPMAC operation with a second input operand and the first weight operand, and the fourth FPMAC unit is configured to perform an FPMAC operation with the second input operand and the second weight operand.

Example 11 provides a method, including transferring a first portion of an input operand of a floating-point multiply-accumulate (FPMAC) operation and a second portion of the input operand from two separate storage units of a memory to an input register file in a processing element, bits in the input operand having a first sequence in the input register file; transferring a first portion of a weight operand of the FPMAC operation and a second portion of the weight operand from two other separate storage units of the memory to a weight register file in the processing element, bits in the weight operand having a second sequence in the input register file; feeding an FPMAC unit of the processing element with the bits in the input operand and the bits in the weight operand based on the first sequence and the second sequence; and performing, by the FPMAC unit, the FPMAC operation based on the input operand and the weight operand to generate an individual partial sum of the processing element.

Example 12 provides the method of example 11, where the first portion of the input operand includes a first half of the bits in the first sequence, and the second portion of the input operand includes a second half of the bits in the first sequence.

Example 13 provides the method of example 11, where the first portion of the weight operand includes a first half of the bits in the second sequence, and the second portion of the weight operand includes a second half of the bits in the second sequence.

Example 14 provides the method of example 11, where the individual partial sum has a different bit precision from the input operand or the weight operand.

Example 15 provides the method of example 11, further includes generating an internal partial sum by accumulating the individual partial sum with an output of another processing element.

Example 16 provides the method of example 15, where the internal partial sum has a same bit precision as the individual partial sum.

Example 17 provides the method of example 11, where the first portion and the second portion of the input operand have same bits arranged in a same sequence.

Example 18 provides the method of example 11, where the input operand is a first input operand of an input matrix, the input matrix further including a second input operand, the weight operand is a first weight operand of a weight matrix, the weight matrix further including a second weight operand, and the method further includes performing FPMAC operations based on the input matrix and the weight matrix.

Example 19 provides the method of example 18, where the FPMAC unit is a first FPMAC unit of the processing element, the FPMAC operation is a first FPMAC operation of the FPMAC operations, and performing the FPMAC operations based on the input matrix and the weight matrix includes performing, by a second FPMAC unit of the processing element, a second FPMAC operation of the FPMAC operations with the first input operand and the second weight operand; performing, by a third FPMAC unit of the processing element, a third FPMAC operation of the FPMAC operations with the second input operand and the first weight operand; and performing, by a fourth FPMAC unit of the processing element, a fourth FPMAC operation of the FPMAC operations with the second input operand and the second weight operand.

Example 20 provides the method of example 19, further including accumulating results of the FPMAC operations.

Example 21 provides one or more non-transitory computer-readable media storing instructions executable to perform operations, the operations including transferring a first portion of an input operand of a floating-point multiply-accumulate (FPMAC) operation and a second portion of the input operand from two separate storage units of a memory to an input register file in a processing element, bits in the input operand having a first sequence in the input register file; transferring a first portion of a weight operand of the FPMAC operation and a second portion of the weight operand from two other separate storage units of the memory to a weight register file in the processing element, bits in the weight operand having a second sequence in the input register file; feeding an FPMAC unit of the processing element with the bits in the input operand and the bits in the weight operand based on the first sequence and the second sequence; and performing, by the FPMAC unit, the FPMAC operation based on the input operand and the weight operand to generate an individual partial sum of the processing element.

Example 22 provides the one or more non-transitory computer-readable media of example 21, where the first portion of the input operand includes a first half of the bits in the first sequence, and the second portion of the input operand includes a second half of the bits in the first sequence.

Example 23 provides the one or more non-transitory computer-readable media of example 21, where the individual partial sum has a different bit precision from the input operand or the weight operand.

Example 24 provides the one or more non-transitory computer-readable media of example 21, where the input operand is a first input operand of an input matrix, the input matrix further including a second input operand, the weight operand is a first weight operand of a weight matrix, the weight matrix further including a second weight operand, and the operations further include performing FPMAC operations based on the input matrix and the weight matrix.

Example 25 provides the one or more non-transitory computer-readable media of example 21, where the FPMAC unit is a first FPMAC unit of the processing element, the FPMAC operation is a first FPMAC operation of the FPMAC operations, and performing the FPMAC operations based on the input matrix and the weight matrix includes performing, by a second FPMAC unit of the processing element, a second FPMAC operation of the FPMAC operations with the first input operand and the second weight operand; performing, by a third FPMAC unit of the processing element, a third FPMAC operation of the FPMAC operations with the second input operand and the first weight operand; and performing, by a fourth FPMAC unit of the processing element, a fourth FPMAC operation of the FPMAC operations with the second input operand and the second weight operand.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. An apparatus for a deep neural network (DNN) includes:
a concatenating module configured to generate an input operand of a floating-point multiply-accumulate (FPMAC) operation, the input operand including a plurality of bits, wherein a first portion of the input operand is stored in a first storage unit of a memory, and a second portion of the input operand is stored in a second storage unit of the memory; and
a processing element comprising:
a register file configured to store the input operand by storing the plurality of bits in a sequence,
a multiplier configured to perform a series of multiplication operations with the plurality of bits based on the sequence, wherein each multiplication operation is with one of the plurality of bits, and
an accumulator configured to perform an accumulation operation with results of the series of multiplication operations and to generate an individual partial sum of the processing element.

2. The apparatus of claim 1, wherein the processing element further comprises an adder that is configured to perform an accumulation operation with the individual partial sum of the processing element and an output of an additional processing element and to generate an internal partial sum, and the processing element and the additional processing element are arranged in a same PE array.

3. The apparatus of claim 2, wherein the adder is further configured to perform an accumulation operation with the internal partial sum and an external partial sum, and the external partial sum is an output of a different PE array.

4. The apparatus of claim 2, wherein a bit precision of the results of the series of multiplication operations is different from a bit precision of the internal partial sum.

5. The apparatus of claim 1, wherein the multiplier and the accumulator are in an electronic circuit that is configured to perform the series of multiplication operations and the accumulation operation.

6. The apparatus of claim 5, wherein the electronic circuit is configured to accumulate a first floating-point number with a second floating-point number by:
changing a first exponent in the first floating-point number based on a second exponent in the second floating-point number before determining whether the second exponent is larger than the first exponent.

7. The apparatus of claim 5, wherein:
the electronic circuit is configured to accumulate a first floating-point number with a second floating-point number,
the first path in the electronic circuit is configured to adjust a first exponent in the first floating-point number based on a second exponent in the second floating-point number,
the second path in the electronic circuit is configured to remove one or more bits having zero values from the first floating-point number or the second floating-point number, and
the second path is separate from the first path.

8. The apparatus of claim 1, wherein:
the concatenating module is further configured to generate a weight operand of the FPMAC operation,
the weight operand including a plurality of bits,
a first portion of the weight operand is stored in a second storage unit of the memory,
a second portion of the weight operand is stored in a third storage unit of the memory, and
a multiplication operation in the series is with a bit of the input operand and a bit of the weight operand.

9. The apparatus of claim 1, wherein the first portion and the second portion include same bits arranged in a same sequence.

10. The apparatus of claim 1, wherein:
the input operand is a first input operand,
the multiplier and the accumulator constitute a first FPMAC unit of the processing element,
the processing element further comprises a second FPMAC unit, a third FPMAC unit, and a fourth FPMAC unit,
the first FPMAC unit is configured to perform an FPMAC operation with the first input operand and a first weight operand,
the second FPMAC unit is configured to perform an FPMAC operation with the first input operand and a second weight operand,
the third FPMAC unit is configured to perform an FPMAC operation with a second input operand and the first weight operand, and
the fourth FPMAC unit is configured to perform an FPMAC operation with the second input operand and the second weight operand.

11. A method, comprising:
transferring a first portion of an input operand of a floating-point multiply-accumulate (FPMAC) operation and a second portion of the input operand from two separate storage units of a memory to an input register file in a processing element, bits in the input operand having a first sequence in the input register file;
transferring a first portion of a weight operand of the FPMAC operation and a second portion of the weight operand from two other separate storage units of the memory to a weight register file in the processing element, bits in the weight operand having a second sequence in the input register file;
feeding an FPMAC unit of the processing element with the bits in the input operand and the bits in the weight operand based on the first sequence and the second sequence; and
performing, by the FPMAC unit, the FPMAC operation based on the input operand and the weight operand to generate an individual partial sum of the processing element.

12. The method of claim 11, wherein the first portion of the input operand includes a first half of the bits in the first sequence, and the second portion of the input operand includes a second half of the bits in the first sequence.

13. The method of claim 11, wherein the first portion of the weight operand includes a first half of the bits in the second sequence, and the second portion of the weight operand includes a second half of the bits in the second sequence.

14. The method of claim 11, wherein the individual partial sum has a different bit precision from the input operand or the weight operand.

15. The method of claim 11, further comprises:
generating an internal partial sum by accumulating the individual partial sum with an output of another processing element.

16. The method of claim 15, wherein the internal partial sum has a same bit precision as the individual partial sum.

17. The method of claim 11, wherein the first portion and the second portion of the input operand have same bits arranged in a same sequence.

18. The method of claim 11, wherein:
the input operand is a first input operand of an input matrix, the input matrix further comprising a second input operand,
the weight operand is a first weight operand of a weight matrix, the weight matrix further comprising a second weight operand, and
the method further comprises performing FPMAC operations based on the input matrix and the weight matrix.

19. The method of claim 18, wherein the FPMAC unit is a first FPMAC unit of the processing element, the FPMAC operation is a first FPMAC operation of the FPMAC operations, and performing the FPMAC operations based on the input matrix and the weight matrix comprises:
performing, by a second FPMAC unit of the processing element, a second FPMAC operation of the FPMAC operations with the first input operand and the second weight operand;
performing, by a third FPMAC unit of the processing element, a third FPMAC operation of the FPMAC operations with the second input operand and the first weight operand; and
performing, by a fourth FPMAC unit of the processing element, a fourth FPMAC operation of the FPMAC operations with the second input operand and the second weight operand.

20. The method of claim 19, further comprising:
accumulating results of the FPMAC operations.

21. One or more non-transitory computer-readable media storing instructions executable to perform operations, the operations comprising:
transferring a first portion of an input operand of a floating-point multiply-accumulate (FPMAC) operation and a second portion of the input operand from two separate storage units of a memory to an input register file in a processing element, bits in the input operand having a first sequence in the input register file;
transferring a first portion of a weight operand of the FPMAC operation and a second portion of the weight operand from two other separate storage units of the memory to a weight register file in the processing element, bits in the weight operand having a second sequence in the input register file;
feeding an FPMAC unit of the processing element with the bits in the input operand and the bits in the weight operand based on the first sequence and the second sequence; and
performing, by the FPMAC unit, the FPMAC operation based on the input operand and the weight operand to generate an individual partial sum of the processing element.

22. The one or more non-transitory computer-readable media of claim 21, wherein the first portion of the input operand includes a first half of the bits in the first sequence, and the second portion of the input operand includes a second half of the bits in the first sequence.

23. The one or more non-transitory computer-readable media of claim 21, wherein the individual partial sum has a different bit precision from the input operand or the weight operand.

24. The one or more non-transitory computer-readable media of claim 21, wherein:
the input operand is a first input operand of an input matrix, the input matrix further comprising a second input operand,
the weight operand is a first weight operand of a weight matrix, the weight matrix further comprising a second weight operand, and
the operations further comprise performing FPMAC operations based on the input matrix and the weight matrix.

25. The one or more non-transitory computer-readable media of claim 21, wherein the FPMAC unit is a first FPMAC unit of the processing element, the FPMAC operation is a first FPMAC operation of the FPMAC operations, and performing the FPMAC operations based on the input matrix and the weight matrix comprises:
performing, by a second FPMAC unit of the processing element, a second FPMAC operation of the FPMAC operations with the first input operand and the second weight operand;
performing, by a third FPMAC unit of the processing element, a third FPMAC operation of the FPMAC operations with the second input operand and the first weight operand; and
performing, by a fourth FPMAC unit of the processing element, a fourth FPMAC operation of the FPMAC operations with the second input operand and the second weight operand.
